(19) United States
(12) Patent Application Publication
(10) Pub. No.: US 2007/0050417 A1
(43) Pub. Date: Mar. 1, 2007

(54) Storage management method and a storage system

(76) Inventors: Toshiyuki Hasegawa, Yokohama (JP); Tatsundo Aoshima, Yokohama (JP); Nobuo Beniyama, Yokohama (JP); Shinichi Ozaki, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/251,912

(22) Filed: Oct. 18, 2005

(30) Foreign Application Priority Data
Aug. 24, 2005 (JP) 2005-242005

(51) Int. Cl. G06F 17/30

(52) U.S. Cl. 707/200

(57) ABSTRACT

In a storage system, a multi-site management system receives a fault notification related to a copy in one or more storage devices from a storage management system, then it requests a storage management system which manages a storage device having a volume in a pair of volumes associated with the fault to transmit information on the pair of volumes. Upon receipt of the transmission request, the storage management system transmits volume pair information to the multi-site management system. The multi-site management system requests storage devices to transmit connection information representing connection topology thereof. Upon receipt of the request for the connection information, each storage management system transmits the connection information associated storage device to the multi-site management system. The multi-site management system identifies a relay path between the pair of volumes associated with the fault from the received connection information, and displays the relay path to the outside.

### INCORPORATION BY REFERENCE

The present application claims priority from Japanese application JP2005-242005 filed on Aug. 24, 2005, the content of which is hereby incorporated by reference into this application.

### BACKGROUND OF THE INVENTION

The present invention relates to a storage system for copying data.

In recent years, functions and scale have been increased more and more in SAN (Storage Area Network) and NAS (Network Attached Storage) in which a storage device is accessed from a plurality of servers through networks. A known exemplary approach utilizes a remote copy function provided in the storage device to copy data for transmission to remote locations, without interrupting other tasks, to improve the redundancy.

Another known approach for increasing the redundancy maintains data synchronized at all times between two remote sites, such that even if a disaster such as earthquake, fire or the like destroys one site, a network associated with the other site is utilized to permit immediate resumption of businesses. A further known approach maintains the redundancy with the aid of three or more sites in consideration of damages which would be suffered when a plurality of sites become unavailable simultaneously due to a global disaster, a harmonized terrorism and the like.

Under such situations, data stored across a plurality of sites must be copied in order to maintain the redundancy in a large-scaled system made up of a plurality sites. In this event, if even one site fails, a failed copy could induce faults in associated sites.

Conventionally, a method has been known for identifying a bottom cause from a plurality of faults in order to address such faults. This method maps information on faults which have occurred to a SAN topology map which is being updated to the most recent state at all times, and determines a problem. from temporal and spatial relationships of faults derived from the mapping (see, for example, JP-A-2001-249856 (corresponding to U.S. Pat. No. 6,636,981)).

### SUMMARY OF THE INVENTION

However, the method described in JP-A-2001-249856 has the following problems when it is applied to a large-scaled system which extends over a plurality of sites. Specifically, a first problem lies in difficulties in creating a SAN topology map in a system made, for example, of several thousands of devices because the amount of information required for the SAN topology map increases in proportion of a square of the number of devices which make up the system. A second problem lies in difficulties in maintaining the latest SAN topology map at all times because a delay occurs in collecting data required to build up the SAN topology map if a narrow communication bandwidth is allocated in a site.

Given the problems set forth above, even if it is difficult to determine the cause of a faulty copy, a need exists for facilitating appropriate measures to be taken to the faulty copy.

It is therefore an object of the present invention to facilitate the performance of appropriate measures against a faulty copy.

To solve the problems described above, the present invention provide a storage management method executed by a computer system which includes a plurality of storage devices, management servers for managing the storage devices, respectively, and a computer for making communications with each of the management servers, wherein each of the management servers comprises a storage unit for storing connection information representing a connection form of the storage device managed thereby, and volume pair information on a pair of volumes which include a volume of the storage device. In response to a notification of a fault received from the management server about a copy in one or a plurality of storage devices, the computer requests a management server which manages a storage device that has a volume included in a pair of volumes associated with the notified fault to transmit the volume pair information on the pair of volumes. In response to the received transmission request, the management server retrieves the requested volume pair information from the storage unit, and transmits the volume pair information to the computer. Upon receipt of the volume pair information, the computer requests a storage device having a volume indicated in the volume pair information to transmit connection information representing a connection form of the storage device. In response to the request for transmitting the connection information, the management server retrieves the requested connection information on the storage device from the storage unit, and transmits the connection information to the computer. Upon receipt of the connection information transmitted thereto, the computer identifies a relay path between the pair of volumes associated with the notified fault from the connection information, and displays the relay path to the outside.

According to the present invention, appropriate actions can be readily taken to a faulty copy.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram generally illustrating an exemplary configuration of a system in a first embodiment of the present invention;

FIG. 2 is a diagram showing an exemplary structure of a volume pair information table used in a first site (Tokyo);

FIG. 3 is a diagram showing an exemplary structure of a volume pair information table used in a second site (Osaka);

FIG. 4 is a diagram showing an exemplary structure of a volume pair table used in a third site (Fukuoka);

FIG. 5 is a diagram showing an exemplary structure of a SAN configuration information table used in the first site (Tokyo);

FIG. 6 is a diagram showing an exemplary structure of a SAN configuration information table used in the second site (Osaka);

FIG. 7 is a diagram showing an exemplary structure of a SAN configuration information table used in the third site (Fukuoka);

FIG. 8 is a diagram showing an exemplary structure of a fault event log information table used in the first site (Tokyo);

FIG. 9 is a diagram showing an exemplary structure of a fault event log information table used in the second site (Osaka);

FIG. 10 is a diagram showing an exemplary structure of a fault event log information table used in the third site (Fukuoka);

FIG. 11 is a diagram showing an exemplary structure of a site information table;

FIG. 12 is a conceptual diagram of an abstract data path;

FIG. 13 is a conceptual diagram illustrating exemplary mapping to a data path;

FIG. 14 is a diagram showing an exemplary structure of a data path configuration information table;

FIG. 15 is a flow chart illustrating an exemplary process of a fault identification program;

FIG. 16 is a flow chart illustrating an exemplary process of a data path routing program;

FIG. 17 is a diagram showing an exemplary structure of the data path configuration information table created at step 661 in FIG. 16;

FIG. 18 is a diagram illustrating an example of a window which is displayed to show identified faults;

FIG. 19 is a flow chart illustrating an exemplary process of a fault monitoring program;

FIG. 20 is a block diagram generally illustrating an exemplary configuration of a system in a second embodiment of the present invention;

FIG. 21 is a diagram showing an exemplary structure of a performance fault event log information table;

FIG. 22 is a diagram showing an exemplary structure of a data path configuration information table (for a performance fault identification program);

FIG. 23 is a flow chart illustrating an exemplary process of a performance fault identification program;

FIG. 24 is a diagram illustrating an example of a window which is displayed to show identified performance faults; and

FIG. 25 is a flow chart illustrating an exemplary process of a performance fault monitoring program.

### DESCRIPTION OF THE EMBODIMENTS

[FIRST EMBODIMENT]

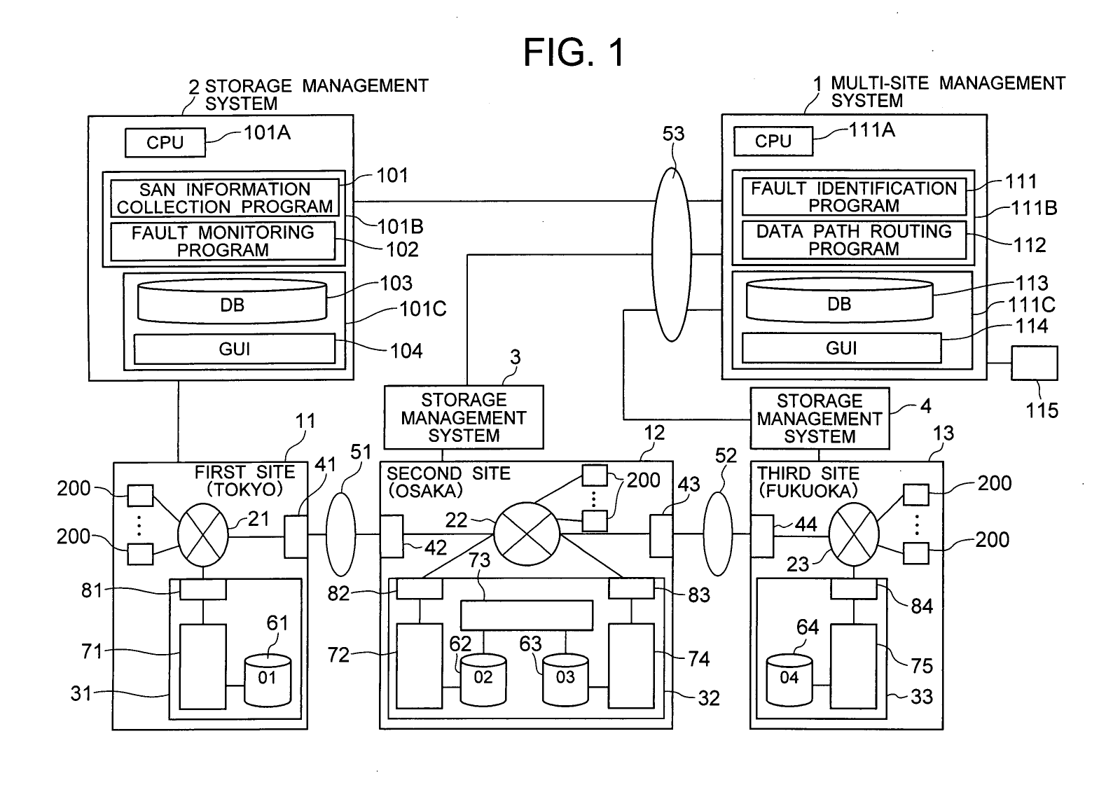

FIG. 1 is a block diagram generally illustrating an exemplary configuration of a system in a first embodiment of the present invention. Illustrated herein is a large-scaled system which comprises three sites 11, 12, 13 in Tokyo (first cite), Osaka (second site), and Fukuoka (third site), respectively.

The respective sites 11-13 are connected to storage management systems (also called the “management servers”) 2, 3, 4, respectively, while the respective storage management systems 2, 3, 4 are connected to a multi-site management system (called the “computer” in some cases) 1 through an IP (Internet Protocol) network 53. The sites 11, 12 are interconnected through an IP network 51. The sites 12, 13 are interconnected through an IP network 52. Though not shown in FIG. 1, there is also an IP network which connects the sites 11, 13 in Tokyo and Fukuoka, respectively, such that the respective sites 11-13 are interconnected with one another.

The respective sites 11-13 are equipped with SAN's (Storage Area Network) 21-23, each of which is connected to a plurality of hosts 200. The SAN 21 is connected to a storage device 31, and an FC-IP (Fibre Channel-Internet Protocol) converter (simply called the “converter” or “repeater” in some cases) 41. Likewise, each of the SAN's 22, 23 is connected to a storage device 32, 33 and a converter 42, 43.

The network topology may be implemented by networks such as dedicated lines among the respective sites 11-13. Also, a network switch may be connected to each of the SAN's 21-23.

[Configuration of Storage Device]

Next, the storage devices 31-33 will be described with regard to the configuration. While a detailed description will be herein given of the storage device 31, the storage devices 32, 33 are similar in configuration, so that repeated descriptions will be omitted as appropriate.

As illustrated in FIG. 1, the storage device 31 comprises a volume 61, a control unit (repeater) 71, and a port (repeater) 81. The control unit 71 has a function of controlling the volume 61, a copy function or a remote copy function, and the like.

The volume 61 represents a virtual storage area formed of one or a plurality of storage devices (hard disk drives or the like) in a RAID (Redundant Array of Independent Disks) configuration. The volume 61 forms a pair of volumes with another volume (for example, the volume 62 in the Osaka site or the like). While one volume 61 is shown in the storage device 31 in FIG. 1, assume that there are a plurality of such volumes in the storage device 31.

A pair of volumes refers to a set of a primary volume (source volume) and a secondary volume (destination volume) using the copy function (copy function in the same storage device) or the remote copy function (copy function among a plurality of storage devices) of the control unit 71, 72, 73, 74, 75.

The storage device 32 comprises two volumes 62, 63; three control units 72, 73, 74; and two ports 82, 83.

[Configuration of Storage Management System]

Next, the storage management systems 2-4 will be described with regard to the configuration. While FIG. 1 shows the configuration of the storage management system 2, the remaining storage management systems 3, 4 are similar in configuration.

The storage management systems 2-4 manage their subordinate sites 11-13, respectively. Specifically, the storage management system 2 manages the site 11 in Tokyo; storage management system 3 manages the site 12 in Osaka; and the storage management system 4 manages the site 13 in Fukuoka.

The storage management system 2 is connected to devices (which represent the hosts, storage device, switch, and FC-IP converter) within the subordinate site 11 through LAN (Local Area Network) or FC (Fibre Channel). Then, the storage management system 2 manages and monitors the respective devices (the hosts, storage device, switch, and FC-IP converter) within the site 11 in accordance with SNMP (Simple Network Management Protocol), API dedicated to each of the devices (the hosts, storage device, switch, and FC-IP converter), or the like.

As illustrated in FIG. 1, the storage management system 2 comprises a CPU (processing unit) 101A, a memory 101B, and a hard disk drive 101C.

The memory 101B is loaded with a SAN information collection program 101, and a fault monitoring program 102. The hard disk drive 101C contains a DB (DataBase) 103 and a GUI 104. GUI, which is the acronym of Graphical User Interface, represents a program for displaying images such as windows. The CPU 101A executes a variety of programs 101, 102, 104.

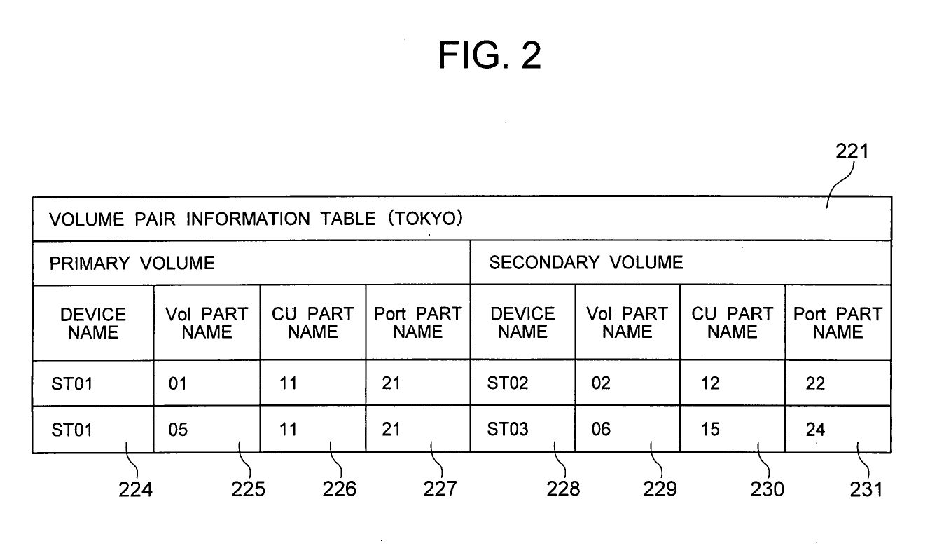

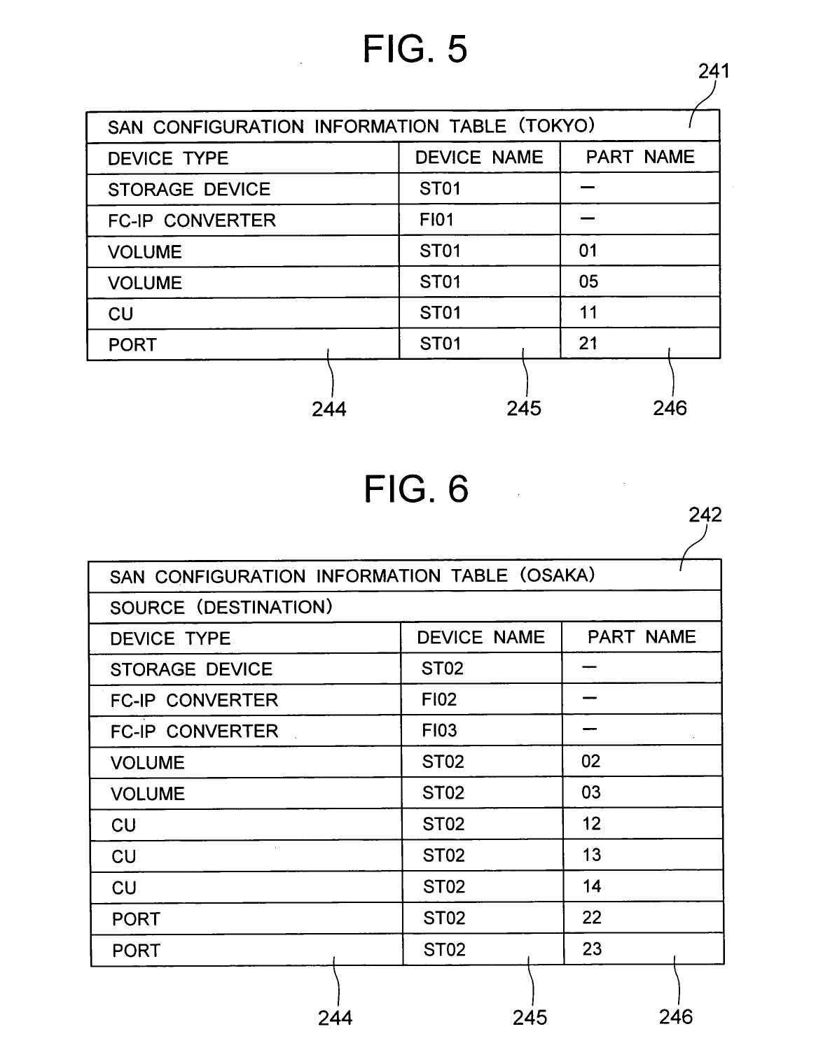

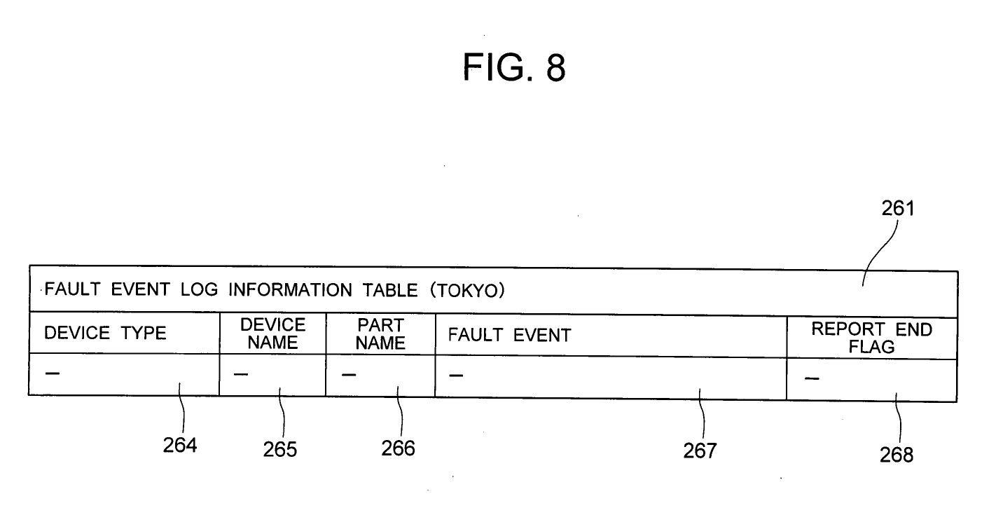

The SAN information collection program 101 collects, on a periodical basis, setting and operational information on the devices (the hosts, storage device, switch, and FC-IP converter) within the sites 11-13 managed by the storage management systems 2-4. The information collected by the SAN information collection program 101 is edited to create a volume pair information table 221 (see FIG. 2), a SAN configuration information table 241 (see FIG. 5), and a fault event log information table 261 (see FIG. 8), each of which is updated and stored in the DB 103 within the storage management system 2.

The fault monitoring program 102 references the fault event log information tables 261-263 (see FIGS. 8 to 10), and transmits a fault event notification message to the multi-site management system 1 about a pair of volumes if it detects a fault related to the pair of volumes.

[Configuration of Multi-Site Management System]

Next, the multi-site management system 1 will be described with regard to the configuration. The multi-site management system 1 is connected to the storage management systems 2-4 of the respective sites 11-13 through the IP network 53.

As illustrated in FIG. 1, the multi-site management system 1 comprises a CPU (processing unit) 111A, a memory 111B, and a hard disk drive 111C.

The memory 111B is loaded with a fault identification program 111 and a data path routing program 112. The hard disk 111C in turn has a DB (DataBase) 113 and a GUI (Graphical User Interface) 114. The CPU 111A executes a variety of programs 111, 112, 114.

Upon receipt of a fault event notification message sent from any storage management system 2-4, the fault identification program 111 selects and collects information for routing a data path (representing the flow of data between a pair of volumes) from each site 11-13 using the data path routing program 112 based on the received fault event notification message. The fault identification program 111, which has collected the data paths, picks up fault events found on the routed data paths from the respective sites 11-13.

Then, the CPU 111A displays a range through which a problem ripples in regard to the identification of faults and operations on a manager terminal (a display device of the computer) 115 of the multi-site management system 1 using the GUI 114. The CPU 111A also transmits a fault alarming message to the sites 11-13 which are located within the fault affected range. Details on these operations will be described later.

[Exemplary Structures of Variety of Tables]

Next, referring to FIGS. 2 to 4, a description will be given of exemplary structures of the volume pair information tables 221-223 managed in the DBs by the respective storage management systems 2-4 which manage the sites 11-13 associated therewith.

FIG. 2 is a diagram showing an exemplary structure of the volume pair information table (called the “volume pair information” in some cases) 221. The volume pair information table 221 is managed in the DB by the storage management system 2 which manages the site 11 in Tokyo.

As shown in FIG. 2, the volume pair information table 221 includes items (columns) belonging to a primary volume and a secondary volume. The primary volume represents a source volume, while the secondary volume represents a destination volume.

The primary volume includes the following items: device name, Vol part name, CU part mane, and Port part name. The device name indicates information for identifying a source storage device (for example, “ST01” indicative of the storage device 31, or the like), and the Vol part name indicates information for identifying the primary volume (for example, “01” indicative of the volume 61, or the like).

The CU part name indicates information for identifying a control unit which controls the primary volume (for example, “11” indicative of the control unit 71, or the like), and the Port part name indicates information for identifying a port which is used by the primary volume (for example, “21” indicative of the port 81, or the like).

The secondary volume also includes the same items as those in the primary volume, i.e., device name, Vol part name, CU part name, and Port part name. The device name indicates information for identifying a destination storage device (for example, “ST02” indicative of the storage device 32, or the like), and the Vol part name indicates information for identifying the secondary volume (for example “02” indicative of the volume 62, or the like).

The CU part name indicates information for identifying a control unit which controls the secondary volume (for example, “12” indicative of the control unit 72, or the like), and the Port part name indicates information for identifying a port which is used by the secondary volume (for example, “22” indicative of the port 82, or the like).

Respective values contained in the table 221 are collected by the function of the SAN information collection program 101 which is resident in the storage management system 2. Specifically, the SAN information collection program 101 in the storage management system 2 inquires the control unit 71 of the storage device 31 as to information on control units (specified by the CU part names 226, 230 in FIG. 2) for controlling the primary volume (specified by the Vol part name 225 in the primary volume in FIG. 2) and the secondary volume (specified by the Vol part name 229 in the secondary volume in FIG. 2), and ports (specified by the Port part names 227, 231 in FIG. 2) on a periodical basis or when a pair of volumes is created. Then, the SAN information collection program 101 collects information sent thereto in response to the inquiry, and creates and/or updates the items (columns) 224-231 of the volume pair information table 221 using the collected information.

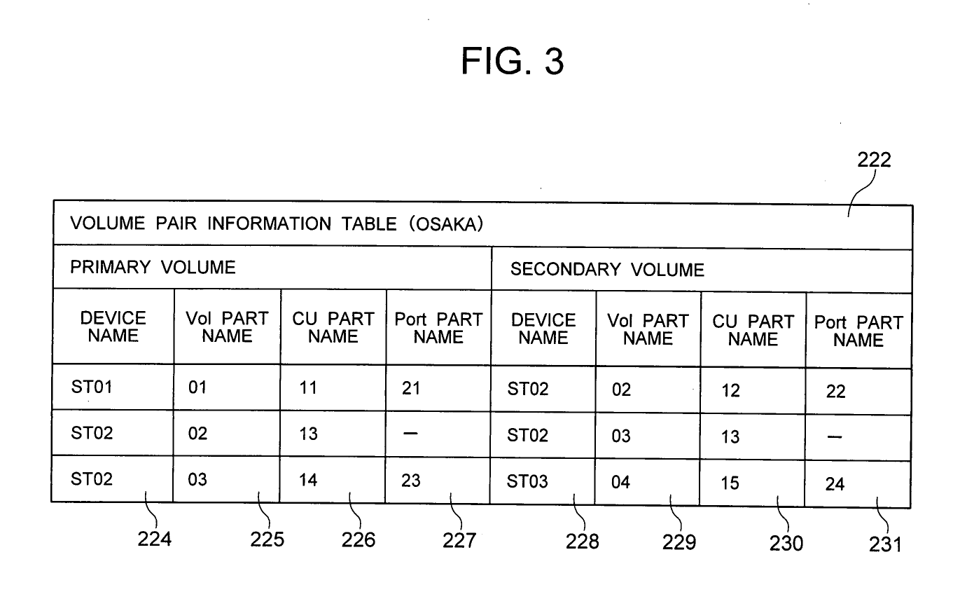

The storage management system 3 for managing the site 12 in Osaka also manages a volume pair information table 222 shown in FIG. 3 in the DB. Further, the storage management system 3 for managing the site 13 in Fukuoka manages a volume pair information table 223 shown in FIG. 3 in the DB. These tables 222, 223 are similar in structure to the table 221 in FIG. 2.

In FIGS. 2 to 4, the device names “ST01”-“ST03” indicate the storage devices 31-33 (see FIG. 1), respectively; the Vol part names “01”-“04” indicate the volumes 61-64 (see FIG. 1), respectively; the CU part names “11”-“15” indicate the control units 71-75 (see FIG. 1), respectively; and the Port part names “21”-“24” indicate the ports 81-84 (see FIG. 1), respectively.

Next, referring to FIGS. 5 to 7, a description will be given of exemplary structures of the SAN configuration information tables 241-243 managed in the DBs by the respective storage management systems 2-4 which manage the sites 11-13, respectively.

FIG. 5 is a diagram showing an exemplary structure of the SAN configuration information table (called “connection information representative of the topology of storage devices” in some cases). The SAN configuration information table 241 is managed in the DB by the storage management system 2 which manages the site 11 in Tokyo.

As shown in FIG. 5, the SAN configuration information table 241 includes the following items (columns): device type, device name, and part name.

The device type indicates the type of a device, i.e., one of the storage device, converter, volume, CU (control unit), and port.

The device name indicates information (for example, “ST01,” “FI01” or the like) for identifying a device (storage device or converter) belonging to the device specified by the device type, and the part name indicates information (for example, “01” or the like) for identifying a part (volume, CU, or port) specified by the device name.

Respective values contained in the table 241 are collected by the function of the SAN information collection program 101 resident in the storage management system 2. Specifically, the SAN information collection program 101 in the storage management system 2 inquires each of the storage device 31 and converter 41 as to information (items 224-226 in FIG. 5) for identifying the location of the volume, control unit, and port, for example, on a periodical basis or when the SAN is modified in configuration. Then, the SAN information collection program 101 collects information sent thereto in response to the inquiry, and creates and/or updates the items (columns) 244-246 in the SAN configuration information table 241 using the collected information.

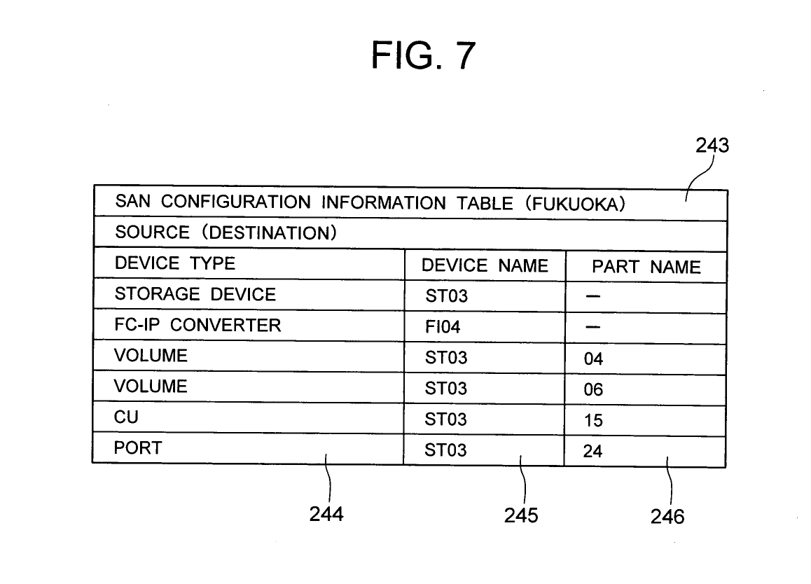

Likewise, the storage management system 3 which manages the site 12 in Osaka manages the SAN configuration management table 242 shown in FIG. 6 in the DB. Further, the storage management system 3 which manages the site 13 in Fukuoka manages the SAN configuration information table 243 shown in FIG. 7 in the DB as well. These tables 242, 243 are also similar in structure to the table 241 in FIG. 5.

In FIGS. 5 to 7, the device names “FI01”-“FI04” indicate the converters 41-44 (see FIG. 1), respectively. “-” indicates null data.

Next, referring to FIGS. 8 to 10, a description will be given of exemplary configurations of the fault event log information tables 261-263 managed in the DBs by the respective storage management systems 2-4, which manage the sites 11-13, respectively.

FIG. 8 is a diagram showing an exemplary structure of the fault event log information table 261. The fault event log information table 261 is managed in the DB by the storage management system 2 which manages the site 11 in Tokyo.

As shown in FIG. 8, the fault event log information table 261 includes the following items (columns): device type, device name, part name, fault event, and report end flag.

The device type indicates the type of a device (port, CU and the like) in which a fault has been detected by the CPU 101A, and the fault event indicates the contents of the fault.

The report end flag indicates that the fault event has been reported to the multi-site management system 1. A symbol “◯” is written into the report end flag when the fault event has been reported, while a symbol “-” is written when not reported.

The items “device name” and “part name” indicate values indicative of the device names and part names shown in FIGS. 5 to 7, respectively.

Respective values contained in the table 261 are collected by the function of the SAN information collection program 101 resident in the storage management system 2. Specifically, the SAN information collection program 101 in the storage management system 2 collects performance information of the volume 61, control unit 71, port 81 and the like from each of the storage device 31 and converter 41, for example, on a periodical basis, or when a fault is detected by SNMP or the like. Then, the SAN information collection program 101 extracts information related to a fault (specified by the fault event 267 in FIG. 8), and information on the location of a device in which the fault has occurred (specified by the items 264-266 in FIG. 8), from the performance information. Then, the SAN information collection program 101 creates the fault event log information table 261 using the extracted information.

The fault monitoring program 102 in the storage management system 2 notifies the multi-site management system 1 of a fault event when it detects, for example, information on a fault in a pair of volumes (fault event) from the fault event log information table 261. A fault in a pair of volumes may be a failed synchronization between the pair of volumes, an internal error in the copy/remote copy program, and the like. Faults not relevant to the pair of volumes may include, for example, faults in devices such as hardware faults, kernel panic, memory error, power failure and the like, faults in communications such as a failed connection for communication, a closed port, link time-out, unarrival of packets, and the like, and faults in the volume such as a closed volume, access error and the like. These faults are also registered in the fault event log information table 261.

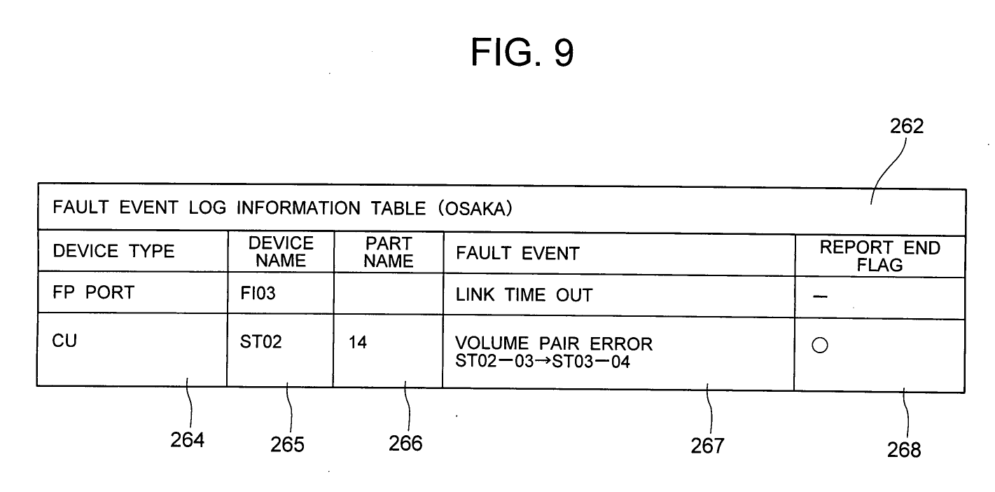

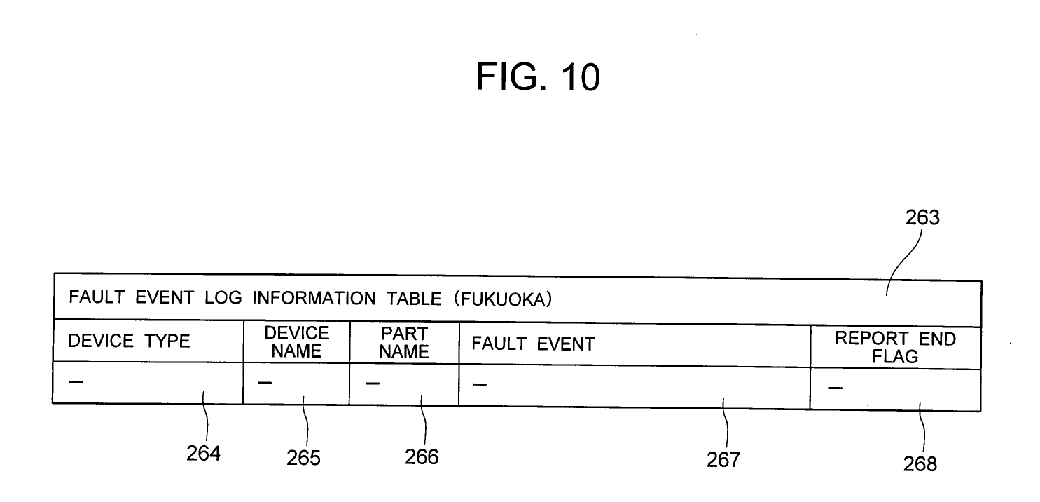

The storage management system 3 which manages the site 12 in Osaka also manages the fault event log information table 262 shown in FIG. 9, resident in the DB. Further, the storage management system 4 which manages the site 133 in Fukuoka manages the fault event log information table 263 shown in FIG. 10, resident in the DB. These tables 262, 263 are similar in structure to the table 261 in FIG. 8.

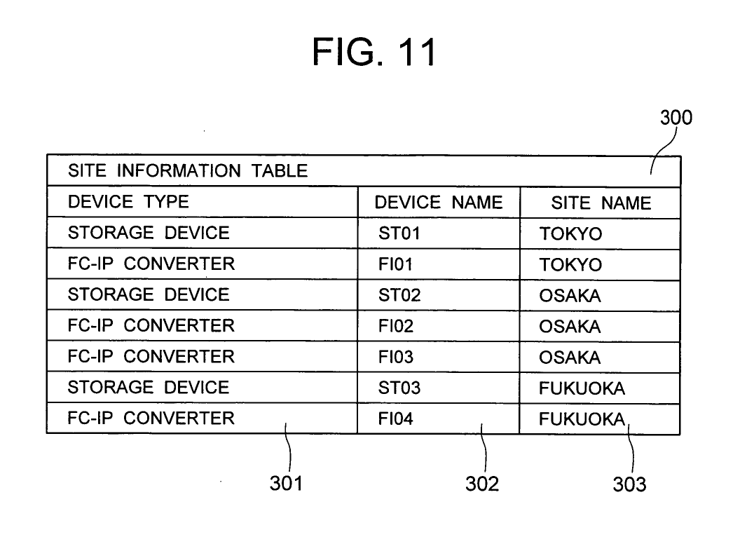

Referring next to FIG. 11, a description will be given of an exemplary structure of a site management table 300 managed in the DB 113 by the multi-site management system 1.

As shown in FIG. 11, the site information table 300 includes the following items (columns): device type, device name, and site name. The device type indicates the type, i.e., either a storage device or a converter, and the device name indicates information for identifying a device specified by the device type. The site name indicates one of the sites in Tokyo, Osaka, and Fukuoka. Such a structure permits the site information table 300 to correspond the storage device or converter to a site in which the device is installed.

The site information table 300 is used for determine whether a request should be made to a storage management system in which site for collecting information on which device, and is created by the multi-site management system 1. Specifically, the multi-site management system 1 references the SAN configuration information tables 221-223 (FIGS. 2-4) in the storage management systems 2-4, respectively, to collect and/or update information (specified by the items 301-303) for identifying the location of each of the storage devices 31-33 and converters 41-44 in the respective sites 11-13. The collection and/or update may be made, for example, at regular time intervals or when a fault event is notified from any of the storage management systems 2-4.

[Specific Example of Abstract Data Path]

Next, a description will be given of an abstract data path which represents a pair of volumes in the abstract.

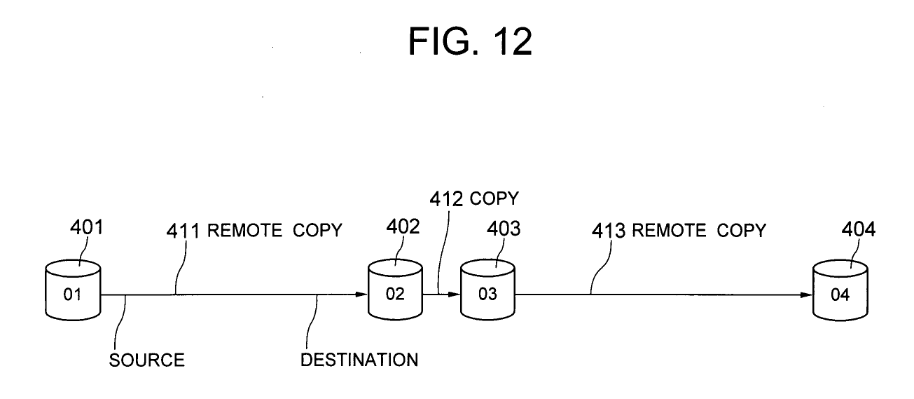

FIG. 12 is a conceptual diagram of an abstract data path. Here, an abstract data path representative of a set of cascaded pairs of volumes is given as an example for description.

FIG. 12 represents an abstract data path which flows in the order of a volume 401 (Vol part name indicated by “01”), a volume 402 (Vol part name indicated by “02”), a volume 403 (“03”), and a volume 404 (“04”).

Among these volumes, giving an eye to the relationship between the volumes 401 and 402, a pair of volumes is formed with the volume 401 serving as a primary volume, and a remote copy 411 is being performed from the volume 401 to 402. This is the same as the relationship shown in the volume pair information table 221 (see the record on the topmost row of FIG. 2). Next, giving an eye to the relationship between the volumes 402 and 403, a pair of volumes is formed with the volume 402 serving as a primary volume, and a copy 412 is being performed from the volume 402 to 403. This is the same as the relationship shown in the volume pair information table 221 (see the second record from the topmost row in FIG. 3).

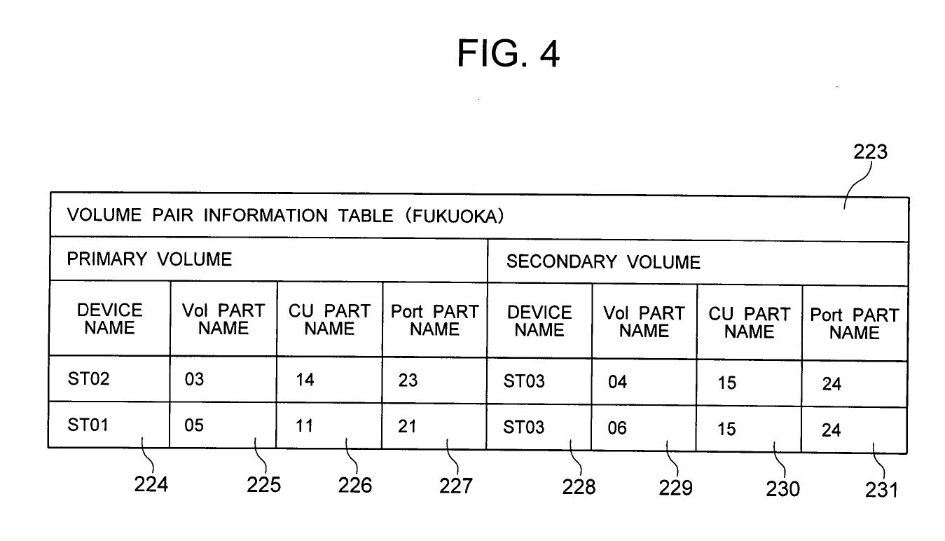

Giving an eye to the relationship between the volumes 403 and 404, a pair of volumes is formed with the volume 403 serving as a primary volume, and a remote copy 413 is being performed from the volume 403 to 404. This is the same as the relationship shown in the volume pair information table 223 (see the topmost record in FIG. 4).

In this way, one abstract data path is composed of three copies 411-413.

It should be noted that in this embodiment, the primary volume side may be referred to as the upstream, and the secondary volume side as the downstream, as viewed from a certain location between the primary volume and the secondary volume which make up a pair of volumes.

[Example of Mapping to Data Path]

Next, a description will be given of an example of mapping of a data path corresponding to the abstract data path illustrated in FIG. 12. The data path refers to a set of devices (control units and the like) which relay data required for actually making a copy from a source volume to a destination volume, mapped to the abstract data path.

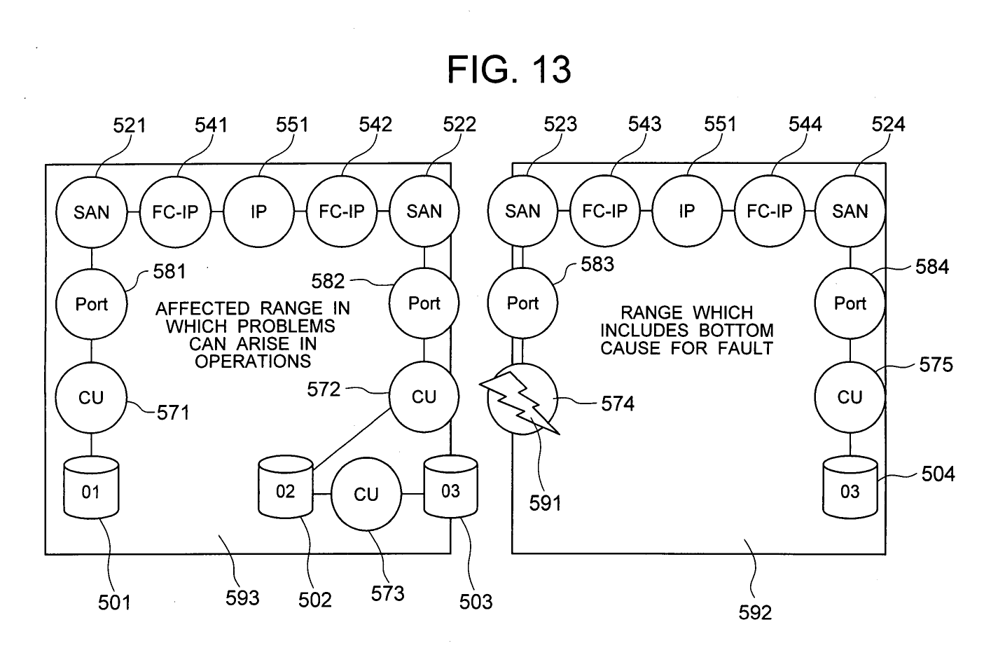

FIG. 13 is a conceptual diagram illustrating an example of mapping to a data path.

Volumes 501-504 shown in FIG. 13 correspond to the volumes 401-404 in FIG. 12, respectively. Then, a control unit 571 (designated by “CU” and corresponding to the control unit 71 in FIG. 1) and the like are shown as mapped between the volumes 501 and 502 in a similar arrangement to the order in which data is relayed when a remote copy is made from the volume 501 to the volume 502.

Specifically, as viewed from the volume 501, the control unit 571, a port 581 (designated by “Port” and corresponding to the port 81 in FIG. 1), a SAN 521 (corresponding to the SAN 21 in FIG. 1), a converter 541 (designated by “FC-IP” and corresponding to the converter 41 in FIG. 1), an IP network 551 (designated by “IP” and corresponding to the IP network 51 in FIG. 1), a converter 542 (designated by “FC-IP” and corresponding to the converter 42 in FIG. 1), a SAN 522 (corresponding to the SAN 22 in FIG. 1), a port 582 (designated by “Port” and corresponding to the port 82 in FIG. 1), and a control unit 572 (designated by “CU” and corresponding to the control unit 72 in FIG. 1) are shown in sequence between the volumes 501 and 502.

Also, a control unit 573 (designated by “CU” and corresponding to the control unit 73 in FIG. 1) is shown between the volumes 502 and 503.

Further, as viewed from the volume 503, a control unit 574 (designated by “CU” and corresponding to the control unit 74 in FIG. 1), a port 583 (designated by “Port” and corresponding to the port 83 in FIG. 1), a SAN 523 (corresponding to the SAN 22 in FIG. 1), a converter 543 (designated by “FC-IP” and corresponding to the converter 43 in FIG. 1), an IP network 551 (designated by “IP” and corresponding to the IP network 52 in FIG. 1), a converter 544 (designated by “FC-IP” and corresponding to the converter 44 in FIG. 1), a SAN 524 (corresponding to the SAN 23 in FIG. 1), a port 584 (designated by “Port” and corresponding to the port 84 in FIG. 1), and a control unit 575 (designated by “CU” and corresponding to the control unit 75 in FIG. 1) are shown in sequence between the volumes 502 and 503.

A symbol 591 represents a fault, and is shown on the control unit 574.

Also, the devices downstream of the control unit 574 (Port, SAN, FC-IP, IP, FC-IP, SAN, Port, CU, and 04 in FIG. 13) are shown in an range 592 in which a bottom cause is found for the fault.

Further, the devices upstream of the control unit 574 (03, CU, 02, CU, Port, SAN, FC-IP, IP, FC-IP, SAN, Port, CU, and 01 in FIG. 13) are shown in an affected range 593 in which problems can arise in operations.

While the data path in FIG. 13 has been described for an illustrative situation in which there is only one path (“01 ”→“02 ”→“03 ”→“04”) among a plurality of sites, the present invention also has an application to a path (“01 ”→“02 ”→“03 ”→“04”) which has a branch to another volume (“02”→another volume).

[Exemplary Structure of Data Path Configuration Information Table]

Next, a description will be given of a data path configuration information table 280 which represents an exemplary mapping to the data path illustrated in FIG. 13.

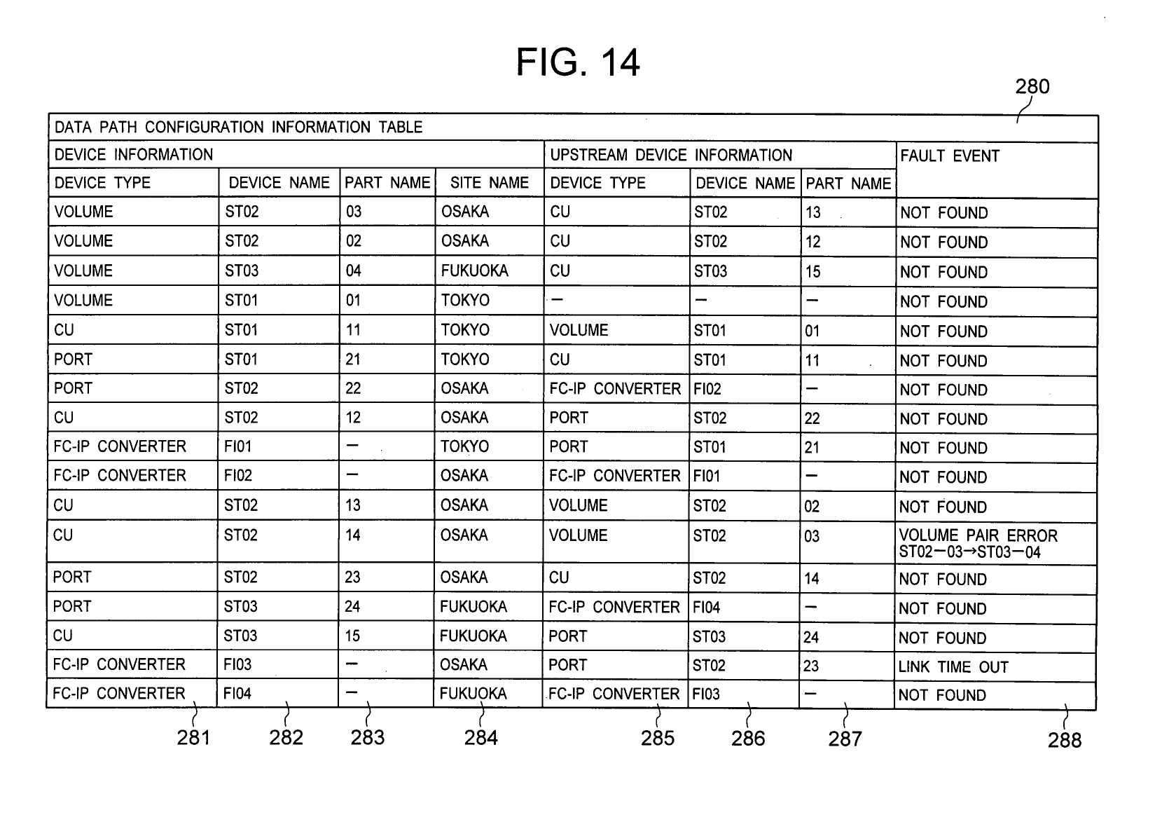

FIG. 14 is a diagram showing an exemplary structure of the data path configuration information table 280. The data path configuration information table 280 includes the following items: device information, upstream device information, and fault event.

The device information indicates in which site a device of interest is installed, and has the following items: device type, device name, part name, and site name. The items “device type,” “device name,” and “part name” contain the respective values of the device type, device name, and part name shown in FIGS. 5-7. The item “site name” shows a site which is under management of the device.

The upstream device information indicates a device (or part) which is located upstream of a device (or part) specified by the device name (or part name) in the device information, and has the following items: device type, device name, part name, and site name (contents similar to the items in the device information).

The fault event indicates contents specified by the fault event in the fault event log information tables 261-263 (see FIGS. 8-10). The contents specified by the fault event can serve as a material for determination used by a user such as a manager to identify a bottom cause for a fault.

The data path configuration information table 280 is created by the function of the data path routing program 112 in the multi-site management system 1. Upon receipt of a fault event notification message from any of the storage management systems 2-4, the data path routing program 112 selects and collects information in respective tables (the volume pair information tables 221-223 in FIGS. 2-4, and the SAN configuration information tables 241-243 in FIGS. 5-7) on the DBs in the respective storage management systems 2-4 to route a data path (relay path).

[Exemplary Process of Fault Identification Program]

Before describing an exemplary process of the fault identification program 111 in FIG. 1, a description will be first given of the principles related to the identification of a bottom cause for a fault, which underlie the process of the fault identification program 111.

In this embodiment, when a detected fault relates to a copy/remote copy, the fault identification program 111 is processed on the assumption that a fault near the downstream end of the data path constitutes the bottom cause for the copy related fault. With this assumption, the data path routing program 112 first collects information required to route a data path associated with the fault, and identifies the bottom cause for the fault from the collected information. Specifically, the data path routing program 112 traces all pairs of volumes associated with volumes which make up a pair of volumes involved in a fault that has occurred in relation to a copy/remote copy. Then, the data path routing program 112 routes an abstract data path from the pairs of volumes which have been collected by the tracing.

Next, the data path routing program 112 routes a data path by mapping connection information on the devices (port, controller and the like) in the storage system to the routed abstract data path. Specifically, between pairs of volumes represented in the abstract data path, the data path routing program 112 newly adds those devices which have relayed data related to the copy/remote copy from a primary volume (source) to a secondary volume (destination)on a path between the primary volume and the secondary volume.

When a fault related to a copy/remote copy occurs on the thus routed data path, the flow of data on the data path is interrupted at any device because the flow of data goes in one direction from the primary volume to the secondary volume. Then, the fault affects other devices that are located in a range of the data path upstream of the device from which the data is prevented from normally flowing. It can therefore be understood from such a feature that the bottom cause for the fault related to a copy/remote copy remains downstream of the fault, and the fault related to the copy/remote copy affects a range of the data path upstream of the fault.

Now, a description will be given of an exemplary process of the fault identification program 111 in FIG. 1.

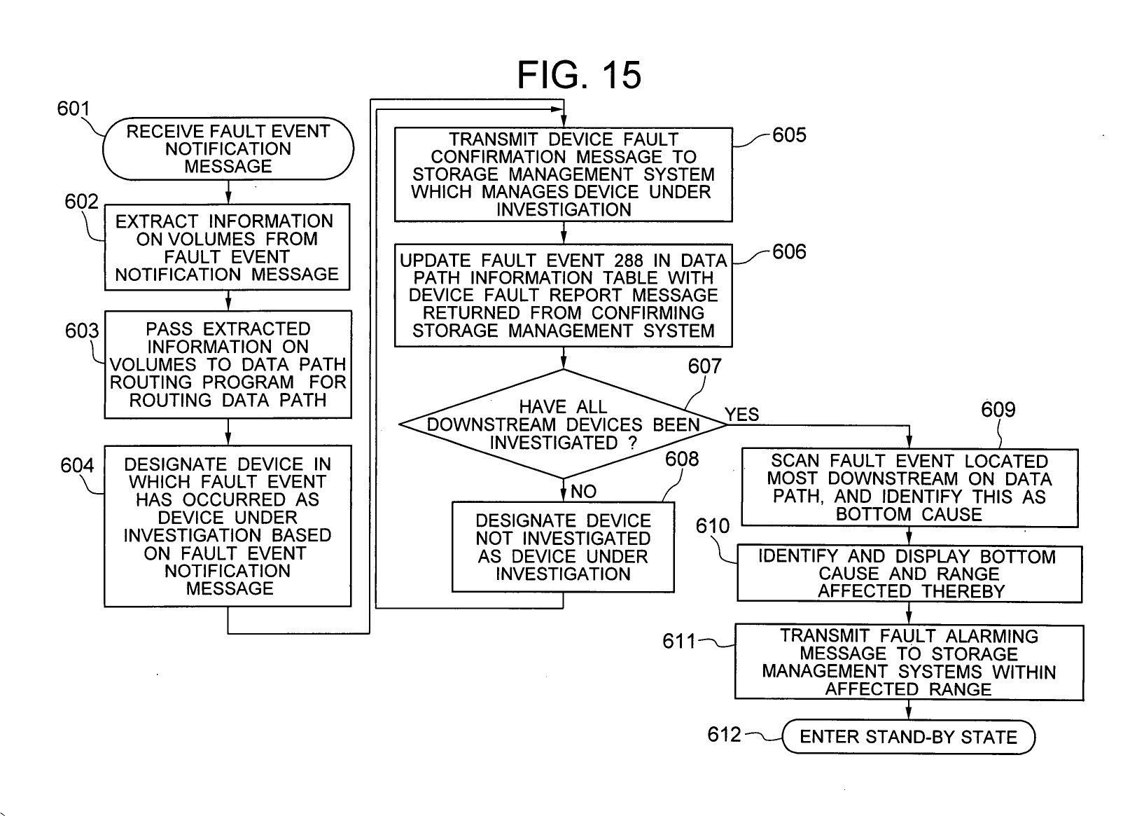

FIG. 15 is a flow chart illustrating an exemplary process of the fault identification program 111. Here, the description will be given on the assumption that the fault monitoring program 102 in the storage management system 3, which manages the site 12 in Osaka, detects a fault related to a pair of volumes (for example, a volume pair error in a control unit) contained in the second row of the fault event log information table 262 (see FIG. 9), by way of example.

In this scenario, in the storage management system 3, the fault monitoring program 102 first retrieves the values in all the items 224-231 included in the rows corresponding to the respective values (CU, ST02, 14) in the items (device type, device name, part name) 264-266 specified on the second row of the fault event log information table 262 (see FIG. 9).

Then, the fault monitoring program 102 transmits to the multi-site management system 1 a fault event notification message which includes the respective values 264, 265 (CU, ST02) of the items (device type, device name) specified on the second row of the fault event long information table 262 (see FIG. 9), and the respective values 224-231 of all the items in the retrieved volume pair information table 222 (see FIG. 3). In this way, the fault identification program 111 executes processing at step 601 onward in FIG. 15 in the multi-site management system 1.

At step 601, the multi-site management system 1 receives a fault event notification message, for example, from the fault monitoring program 102 in the storage management system 3. In response, the fault identification program 111 starts executing by extracting information on volumes from the received fault event notification message (step 602). Specifically, at step 602, the fault identification program 111 retrieves the values 224, 225 (the values in the device name and Vol part name of the primary volume in FIG. 3) related to the volume 63 which is the primary volume (of a pair of volumes in which a fault has occurred) from the respective values 224-231 in the fault event notification message.

At step 603, the fault identification program 111 passes the information (values 224, 225) on the volume 63 extracted from the fault event notification message to the data path routing program 112, and requests the same to route a data path.

In response to this request, the data path routing program 112, which has received the information 224, 225 on the volume 63, routes a data path based on the information 224, 225 on the volume 63, and returns information on the configuration of the routed data path to the fault identification program 111 as the data path configuration information table 280.

At step 604, upon receipt of the information on the configuration of the data path from the data path routing program 112, the fault identification program 111 designates a device, included in the fault event notification message, in which the fault has been detected, as a device under investigation. In this embodiment, the fault event notification message includes the values 264-266 indicative of the device in which the fault has been detected (device type, device name, and part name in the fault event log information table in FIG. 9). Consequently, the control unit 74 specified by the value 264 is designated as a device under investigation.

At step 605, the fault identification program 111 transmits a device fault confirmation message to the storage management system which manages the device under investigation.

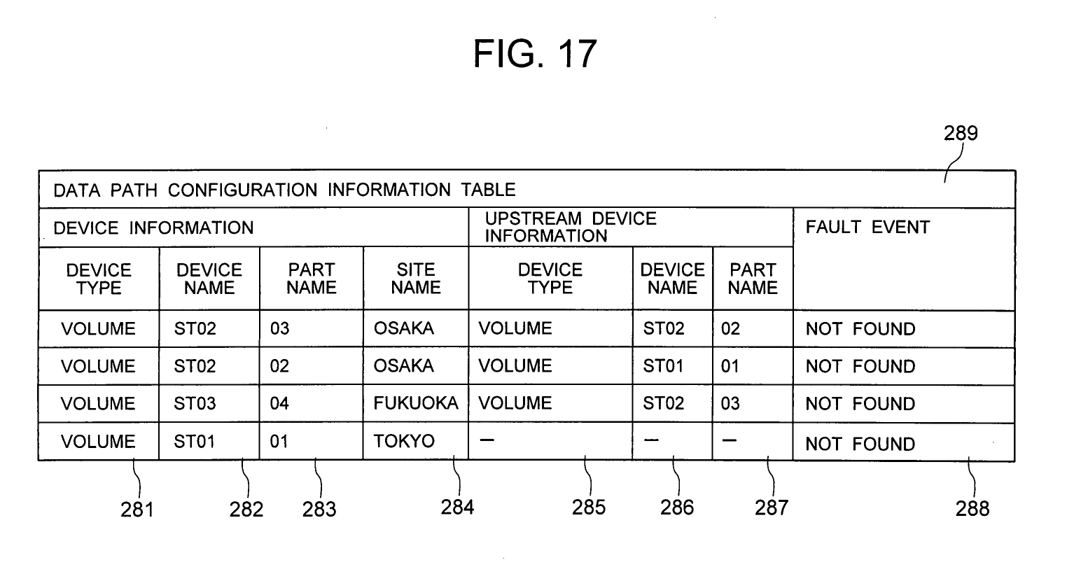

In this embodiment, the device under investigation is the control unit 74, and it is the storage management system 3 (specified by the item 265 in the fault event notification message) which manages the control unit 74. The device fault confirmation message includes the values in the respective items 281-283 (device type, device name, part name) in the data path configuration information table 289 (see FIG. 17).

Upon receipt of a transmission from the fault identification program 111, the storage management system 3 (called the “confirming storage management system” in some cases) searches the fault event log information table 262 (see FIG. 9). As a result of the search, when the storage management system 3 finds a fault event log related to the device type, device name, and part name specified by the values 281-283, respectively, in the received device fault confirmation message, the storage management system 3 transmits to the multi-site management system 1 a device fault report message including the data contents 267 (see the volume pair error, ST02-03→ST03-04 in FIG. 9) of the fault event indicated by the fault event log.

On the other hand, if no fault event log is found, the storage management system 3 transmits to the multi-site management system 1 a device fault report message which includes the value of “null.”

At step 606, upon receipt of the transmission from the storage management system 3, the multi-site management system 1 updates the fault event in the data path information table 289 (see FIG. 17) using the device fault report message returned from the storage management system 3 which is in the position of the confirming storage management system. This update involves, for example, storing the value (for example, “null”) included in the received device fault report message as the value 288 for the fault event in the data path information table 289.

After completion of step 606, the fault identification program 111 determines at step 607 whether or not it has investigated all devices located downstream of the control unit 74 on the data path (see FIG. 13) represented by the data path configuration information table 280 (see FIG. 14). Specifically, this determination involves tracing the respective values 285-287 in the items (device type, device name, part name) in the information on upstream devices in the data path configuration information table 280 (see FIG. 17) to confirm whether or not there is any device (located downstream of the control unit 74) which can reach the control unit 74 (in which the fault has been detected) specified by the value 264 in the fault event notification message received at step 601.

If the result of the confirmation shows that such a device is found (No at step 607), the fault identification program 111 designates this device (device not investigated) as a device under investigation (step 608), and returns to step 605 to execute the processing at step 605 onward. On the other hand, if such a device is not found (Yes at step 607), the fault identification program 111 finds out a fault event located most downstream of the data path (a fault event in FIG. 14 which has occurred in the device that is most frequently traced from the device at the upstream end), and identifies this fault event as a bottom cause (step 609).

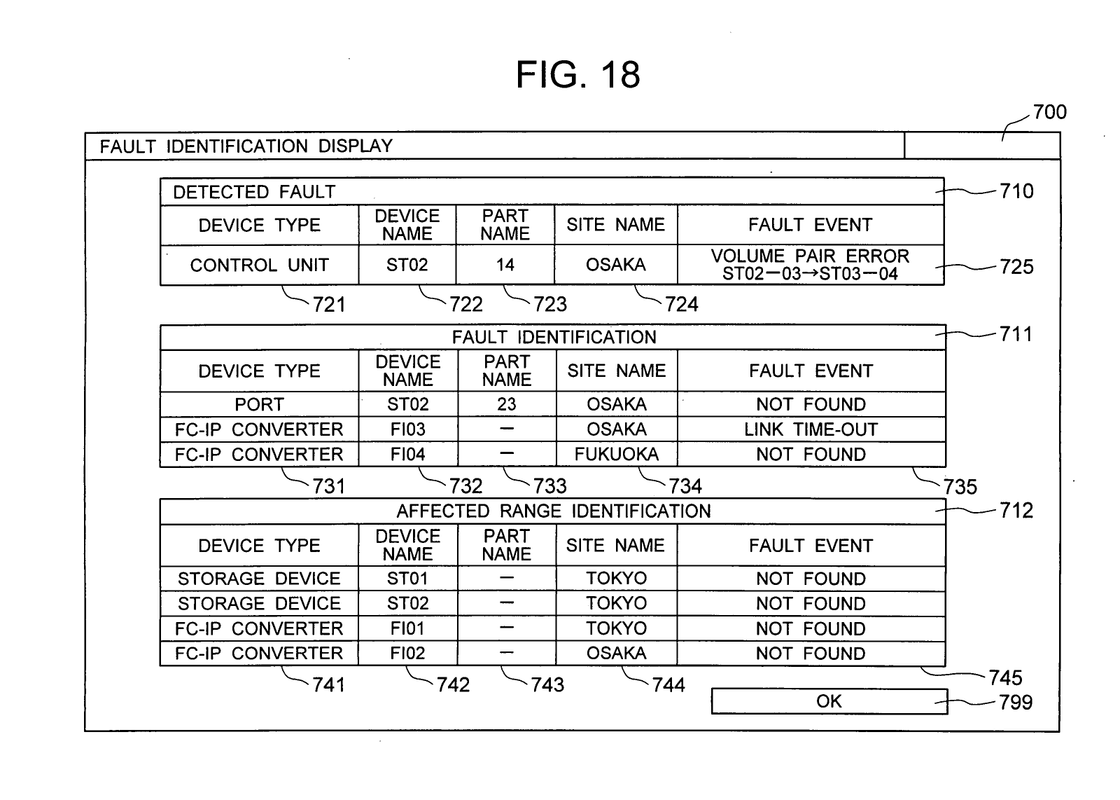

At step 610, the fault identification program 111 displays the identified bottom cause and a range affected thereby, for example, on the display device of the computer. An exemplary display will be described later in detail with reference to FIG. 18.

At step 611, the fault identification program 111 transmits a fault alarming message to the storage management systems 2-4 which fall within the range affected by the fault, identified at step 610, and proceeds to step 612 where the fault identification program 111 enters a next fault event waiting state (stand-by state). The storage management systems 2-4 receive the fault alarming message transmitted at step 611, and store the data path configuration information table 280 in their respective DBs.

[Exemplary Process of Data Path Routing Program]

Next, a description will be given of an exemplary process executed by the data path routing program 112 (see FIG. 1) which receives information on the volume (the values 224, 225 of the device name and Vol part name in FIG. 3) passed at step 603 in FIG. 15.

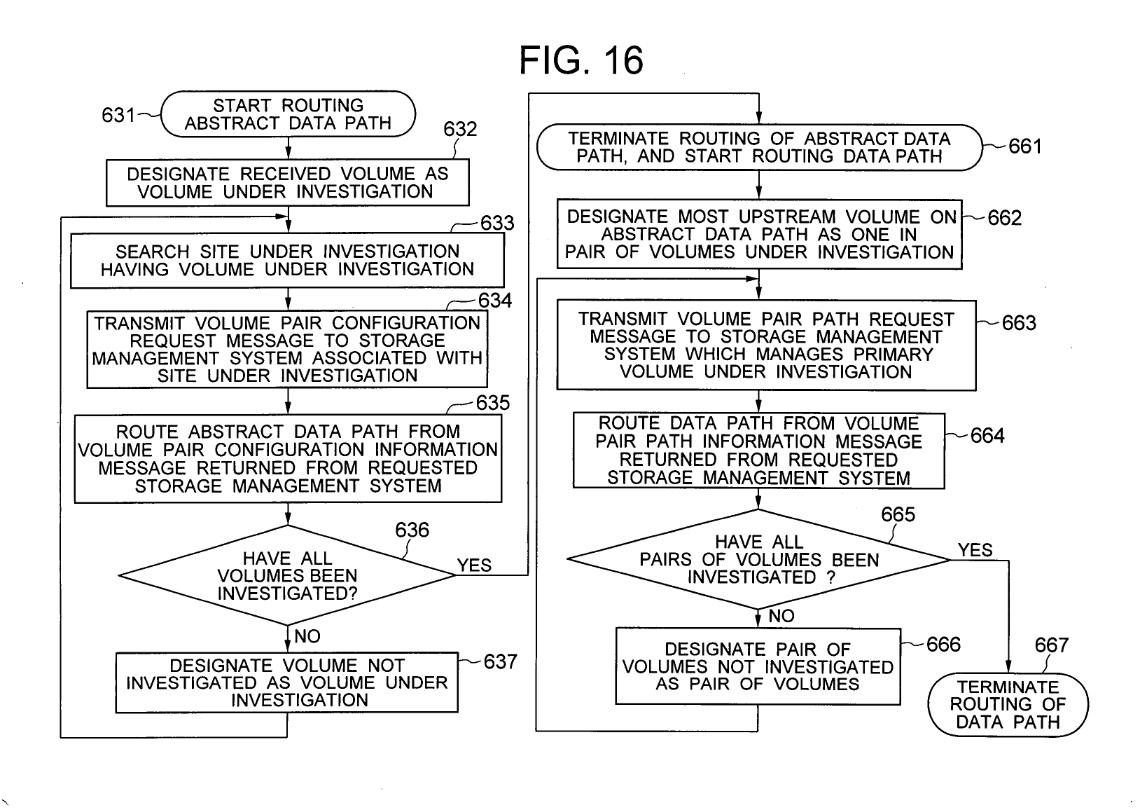

FIG. 16 is a flow chart illustrating an exemplary process executed by the data path routing program 112.

At step 631, the data path routing program 112 receives the information on the volume (the values 224, 225 of the device name and Vol part name in FIG. 3) passed thereto at step 603 in FIG. 15, and start routing an abstract data path.

At step 632, the data path routing program 112 designates the volume specified by the received information as a volume under investigation.

Specifically, the data path routing program 112 writes the received information (the values 224, 225 of the device name and Vol part name in FIG. 3) into the items (columns) “device type” 281, “device name” 282, and “part name” 283 in the newly created data path configuration information table 280 (see Fig. 14). The data path routing program 112 also writes the value “-” into all the items (columns) “device type” 285, “device name” 286, and “part name” 287 of the data path configuration information table 280 (see FIG. 14). Then, the data path routing program 112 designates as a volume under investigation a volume specified on the first row of the thus written data path configuration information table 280 (see FIG. 14). It should be noted that all the items (columns) “device type” 285 “device name” 286, and “part name” 287 containing the value “-” indicate the upstream end of the data path represented by the data path configuration information table 280.

At step 633, the data path routing program 112 searches for a site under investigation which has a volume under investigation. Specifically, the data path routing program 112 examines a site specified by the site name 303 (see the site information table 300 in FIG. 11) which contains a device specified by the device name 282 from the device information in the data path configuration information table 280 (see FIG. 14). Then, when the examined site is, for example, “Osaka,” the data path routing program 112 writes “Osaka” into the site name 284 on the first row of the data path configuration information table 280 (see FIG. 14).

At step 634, the multi-site management system 1 transmits a volume pair configuration request message to the storage management system associated with the site under investigation. Specifically, for example, the multi-site management system 1 transmits the volume pair configuration request message including the respective values of the device name 282 and part name 283 on the first row of the data path configuration information table 280 (see FIG. 14) to the storage management system 3 which manages the site (for example, in Osaka) identified by the site name 284 on the first row of the data path configuration information table 280 (see FIG. 14), written at step 633.

Upon receipt of the transmitted request message, the storage management system 3 searches the volume pair information table 222 (see FIG. 3), for example, for information (items 224, 225 of the primary volume and items 228, 229 of the secondary volume in FIG. 3) for identifying the locations of all volumes (primary volume and secondary volume) which form a pair with the volume 63 (see FIG. 1) that represents the value specified by the part name 283.

The storage management system 3 transmits to the multi-site management system 1 a volume pair configuration message which contains information for identifying the locations of all retrieved volumes, which form pairs with the volume 63 (the values in the items 224, 225 of the primary volume on the second row of the volume pair information table 222 in FIG. 3, and the values in the items 228, 229 of the secondary volume on the third row of the volume pair information table 222 in FIG. 3.

Upon receipt of the volume pair configuration information message from the storage management system 3, the multi-site management system 1 routes an abstract data path using the volume pair configuration information message (step 635). Specifically, the multi-site management system 1 examines whether or not the information (the respective values in the items 224, 225 of the primary volume in FIG. 3) on the volume 62, which is the primary volume paired with the volume 63, is repeated in the data path configuration information table 280 (see FIG. 14). If the result shows no repetition, the multi-site management system 1 writes the information on the volume 62 (the respective values in the items 224, 225 of the primary volume in FIG. 3), and the site name of the volume into the items 281-283 on the second row of the data path configuration information table 280.

Also, the multi-site management system 1 writes the values in the items 285-287 on the first row, related to the secondary volume paired with the volume 62, into the items 285-287 on the second row of the data path configuration information table 280, and writes the values in the items 281-283 on the second row, related to the volume 62 which is the primary volume, into the item 285-287 on the first row of the data path configuration information table 280.

On the other hand, if any repetition is found, the information on the volume 62 (the respective values in the items 224-225 of the primary volume in FIG. 3) is not written into the data path configuration information table 280.

Then, the multi-site management system 1 examines whether or not the information (the respective values in the items 224, 225 of the primary volume in FIG. 4) on the volume 64, which is a secondary volume paired with the volume 63, is repeated in the data path configuration information table 280. If the result shows no repetition, the multi-site management system 1 writes the information on the volume 64 (the respective values in the items 224, 225 of the primary volume in FIG. 3), and the site name of the volume into the items 281-283 on the third row of the data path configuration information table 280. The multi-site management system 1 also writes the values in the items 281-283 on the first row into the items 285-287 on the third row. On the other hand, if there is any repetition, any information on the volume 64 is not written into the data path configuration information table. In the foregoing manner, the multi-site management system 1 terminates the investigation on the volume 63 on the first row of the data path configuration information table 280.

After step 635, the multi-site management system 1 determines at step 636 whether or not the investigation has been completely made on all the volumes shown in the data path configuration information table 280. This determination involves examining whether or not there is any row which includes data that is next designated as data under investigation.

Then, if the next row contains data which is to be investigated (No at step 636), the flow returns to step 633 with the row designated as being under investigation (step 637).

On the other hand, if the next row does not contain data which is to be investigated (Yes at step 636), this means that the overall abstract data path has been routed, so that the data path routing program 112 terminates the routing of the abstract data path and starts routing a data path (step 661). The data path configuration information table at this time is created as shown in FIG. 14, generally designated by 289.

Turning back to FIG. 16, at step 662, the data path routing program 112 designates a volume at the upstream end of the completed abstract data path as one of a pair of volumes under investigation. Specifically, the data path routing program 112 searches the data path configuration information table 289 (see FIG. 17) for a volume in the item 281 on a row on which all the items 285-287 contain the value of “-” to determine one of a pair of volumes under investigation.

At step 663, the multi-site management system 1 transmits a volume pair path request message including the respective values in the items 281, 282 of the primary volume 61 and secondary volume 62 to the storage management system 2 which manages the site (for example in Tokyo) 11 in the item 284 of the primary volume in the pair of volumes under investigation.

Upon receipt of the transmitted request message, the storage management system 2 traces a path made up of devices that relay copy data, delivered from the primary volume to the secondary volume, of each of the values included in the received volume pair path request message, using the volume pair information table 221 (see FIG. 2) and SAN configuration information table 241 (see FIG. 5). Then, the storage management system 2 transmits to the multi-site management system 1 the result of the trace (the respective values in the items 224-231 on the first row of the volume pair information table 221 in FIG. 2, and the value in the device name 245 of the converter (which is included in the relay path for the copy data) in the SAN configuration information table 241 in FIG. 5) which is included in a volume pair path information message.

At step 664, upon received of the volume pair path information message, the multi-site management system 1 routes a data path based on the volume pair path information message returned from the requested storage management system. Specifically, the multi-site management site 1 retrieves information on the two control units 71, 72 which control the pair of volumes composed of the primary volume 61 and secondary volume 62, and two ports 81, 82 (the respective values in the items 224-231 on the first row of the volume pair information table 221 in Fig: 2) from the volume pair path information message. Then, the multi-site management system 1 writes the retrieved information into the device type 281, device name 282, and part name 283 on the fifth row (related to the control unit 71), the sixth row (related to the port 81), the seventh row (related to the port 82), and the eighth row (related to the control unit 72) of the data path configuration information table 280.

The site information table 300 (see FIG. 11) is searched using the value “ST01” in the device name 282, as a key, on the fifth row (related to the control unit 71) of the data path configuration information table 280. Then, “Tokyo,” for example, is written into the site name 284 corresponding to the key. Also, the values in the items 281-283 (device type, device name, and part name in the device information in FIG. 14) are written into the items 285-287 (device type, device name, and part name in the upstream device information in FIG. 14) on the fifth row, respectively.

Likewise, on the sixth, seventh, and eighth rows of the data path configuration information table 280, associated values are written into the items 284-287 (site name, and device type, device name, and part name of the upstream device information). Finally, on the second row (related to the volume 62) of the data path configuration information table 280 (see FIG. 14) related to the secondary volume, the values in the items 285-287 are rewritten to the values in the items 281-283 on the eighth row (related to the control unit 72).

Next, the multi-site management system 1 executes processing related to information on devices which are located between the ports 81 and 82. Specifically, the multi-site management system 1, relying on the received volume pair path information message, writes information related to the two converters 41, 42 into the items 281-287 on the ninth row (related to the converter 41) and tenth row (related to the converter 42) of the data path configuration information table 280. Finally, the multi-site management system 1 rewrites the values in the items 285-287 on the seventh row (related to the port 82) to the values in the items 281-283 on the tenth row (related to the converter 42).

At step 665, the multi-site management system 1 determines whether or not the investigation has been completely made on all volume pair paths on the data path. This determination involves a confirmation which is made by determining whether or not the data path configuration information table 289 (see FIG. 17) contains a row which has the two items 281, 285, both of which contain “volume.”

If the result of the confirmation shows that there is a row which has the two items 281, 285, both of which contain “volume,” the multi-site management system 1 determines that the investigation has not been completed (No at step 665), designates a pair of volumes consisting of the volumes indicated on the row as being under investigation (step 666), and returns to step 663 to execute the processing at step 663 onward. On the other hand, upon determining that the investigation has been completed (Yes at step 665), the multi-site management system 1 proceeds to step 667 to terminate the routing of the data path (step 667). After the termination, the CPU 111A in the multi-site management system 1 displays a relay path representative of the routed data path on the manager terminal 115. This display screen displays a relay path as illustrated in FIG. 13. The displayed relay path permits the user to readily take appropriate actions on a copy fault.

A path of devices from the port 81 through the port 82 may be traced, for example, by the following method. First, a switch (not shown) having a function of managing the topology (network connection form including ports) of the SAN is inquired as to a relay path from the port 81 to the port 82. Then, a response to the inquiry is received from the switch, and information on the two converters 41, 42 on the relay path is extracted from the response, and written into the data path configuration information table 289.

Nevertheless, a plurality of paths (combinations of converters) can be established in order to improve the redundancy of data, in which case a number of record are created for the port 82, which is the termination of the path, as many as the number of the paths. Then, the items 285-287 (device type, device name, and part name of the upstream device information in FIG. 17) for identifying a device located upstream of the port 82 are rewritten to values indicative of the upstream of respective paths. In this way, a plurality of paths can be represented.

When a public line network such as an IP network is utilized for a remote copy, the path is not traced because the storage management system cannot manage relay paths using the public line network.

[Specific Example of Fault Specific Display]

Next, FIG. 18 illustrates an example of the display made at step 610 in FIG. 15. This exemplary display is shown using a window 700 outputted by the GUI 114 in the multi-site management system 1.

As illustrated in FIG. 18, the window 700 comprises a detected fault display list 710, a fault identification display list 711, and an affected range identification display list 712. Specifically, the detected fault display list 710 includes the following items: device type, device name, part name, site name, and fault event. The fault identification display list 711 includes the following items: device type, device name, part name, site name, and fault event. The affected range identification display list 712 in turn includes the following items: device type, device name, part name, site name, and fault event. A button 799 is provided for instructing the GUI 114 to terminate the display made thereby.

The user, when viewing the window 700 as described above, can confirm from the detected fault display list 710 and the like that a volume pair error has been detected in the control unit in the Osaka site.

For displaying information 721-725 in the detected fault display list 710, values corresponding to the values 224-231 (see FIGS. 2-4) in the fault event notification message received at step 601 (see FIG. 15) are retrieved from the data path configuration information table 280.

Information 731-735 in the fault identification display list 711 comprises information on a device associated with a bottom cause for a fault identified at step 610 (see FIG. 15), and information on devices located immediately upstream and downstream of that device, and the information is extracted from the data path configuration information table 280 for display. If redundant paths are routed so that there are a plurality of upstream or downstream devices, information on these devices is all extracted from the data path configuration information table 280 for display.

Information 741-745 in the affected range identification display list 712 relates to those devices which fall within the affected range identified at step 610.

[Exemplary Process Performed by Fault Monitoring Program in Storage Management Systems]

Next, a description will be given of an exemplary process performed by the fault monitoring program 102 in the storage management systems 2-4.

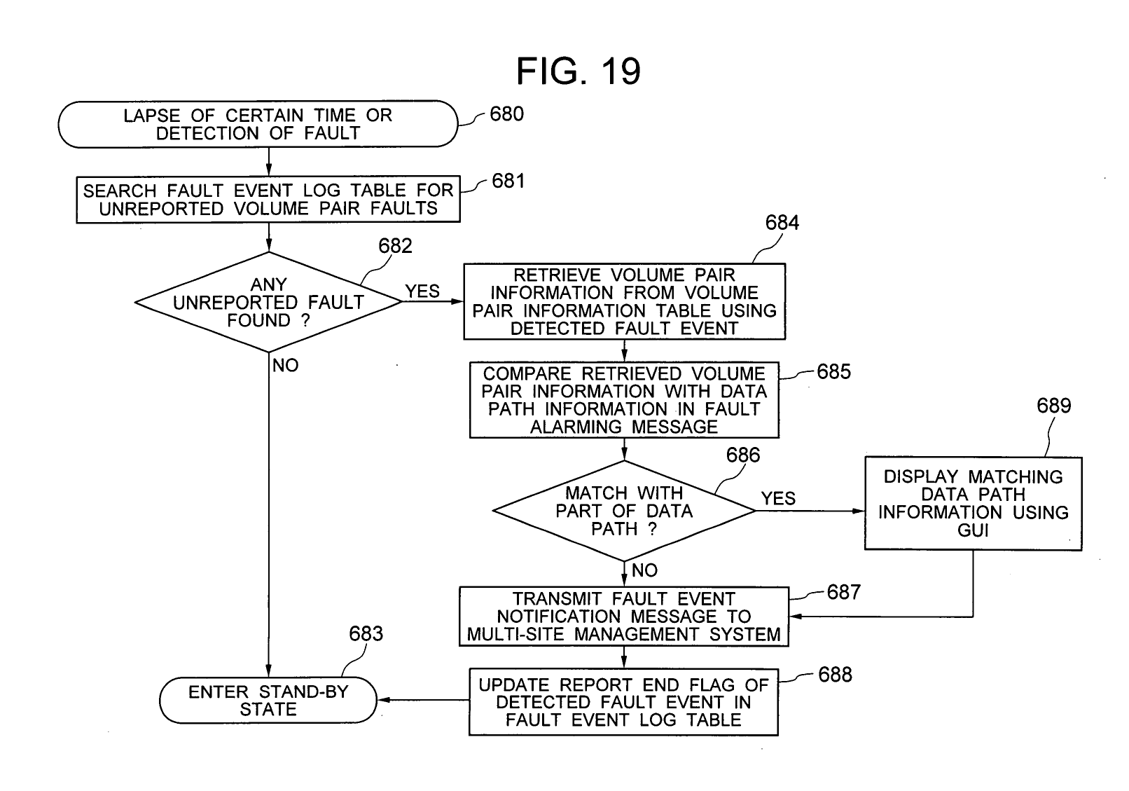

FIG. 19 is a flow chart illustrating an exemplary process performed by the fault monitoring program 102. While the storage management system 2 is given herein as an example for description, a similar process is also performed in the remaining storage management systems 3, 4.

The fault monitoring program 102 in the storage management system 2 proceeds to step 681 when a certain time has elapsed or when a fault is detected by SNMP (step 680).

At step 681, the fault monitoring program 102 searches the fault event log information table 261 (see FIG. 8) in the storage management system 2 loaded with the fault monitoring program 102 for volume pair faults which have not been reported. Then, the fault monitoring program 102 determines from the result of the search whether or not any unreported fault has been found (step 682). Specifically, the fault monitoring program 102 determines whether or not there is any fault event (related to a pair of volumes) on rows of the fault event log information table 261 (see FIG. 8) other than those which contain the report end flag indicative of “◯” (“◯” indicates a reported fault)

Then, if no unreported fault is found at step 682 (No at step 682), the fault monitoring program 102 enters a stand-by state (step 683). On the other hand, if any unreported fault is found at step 682 (Yes at step 682), the fault monitoring program 102 regards a fault event associated with the unreported fault (fault event in the fault event log information table of FIG. 8), as a detected fault event, and retrieves volume pair information related to the detected fault event (the respective values in the items 224-231 in FIG. 2) from the volume pair information table 221 (see FIG. 2) using the detected fault event as a key (step 684).

At step 685, the fault monitoring program 102 compares the retrieved volume pair information with the data path information in the fault alarming message. A determination is made from the result of the comparison whether or not the volume pair information matches part of the data path (step 686). Specifically, the fault monitoring program 102 loaded in the storage management system 2 searches the data path configuration information table 280 in the received fault alarming message to determine whether or not the data path configuration information table 280 contains all the information, retrieved at step 684, on the pair of volumes (the respective values in the items 224-231 in FIG. 2) associated with the detected fault event.

Then, if the result of the comparison at step 686 shows that the data path configuration information table 280 does not contain all the information (No at step 686), the fault monitoring program 102 transmits a fault event notification message to the multi-site management system 1 (step 687). Specifically, at step 687, the fault monitoring program 102 transmits to the multi-site management system 1 the fault event notification message which includes information on a device in which the detected fault event has occurred (the respective values in the items 264-266 in FIG. 8), and information on the pair of volumes (items 224-231 in FIG. 2).

Next, the fault monitoring program 102 updates the report end flag associated with the detected fault event in the fault event log information table 261 (step 688), and enters a stand-by state (step 683). Specifically, at step 688, the fault monitoring program 102 writes the symbol “◯” (indicating that the fault event has been reported) into the report end flag in the fault event log information table 261 (see FIG. 8).

On the other hand, if the data path configuration information table 280 (see FIG. 14) contains all the information, as determined at step 686 (Yes at step 686)), the fault monitoring program 102 displays the window 700 (see FIG. 17) on the display device of the computer using the GUI 104 in the storage management system 2 (step 689), and executes the processing at step 687 onward.

[Second Embodiment]

A second embodiment mainly features in that a performance fault event is substituted for the fault event used in the first embodiment. The performance fault event is notified when a previously set threshold for a performance index is exceeded in a device (controller, port, cache, memory and the like) which is monitored for performance indexes such as the amount of transferred input/output data. The performance indexes may include a communication bandwidth, a remaining capacity of a cache, and the like in addition to the amount of transferred input/output data. Anyway, the performance indexes of a device may be monitored by the device itself, or may be collectively monitored by a dedicated monitoring apparatus or the storage management systems 2-4.

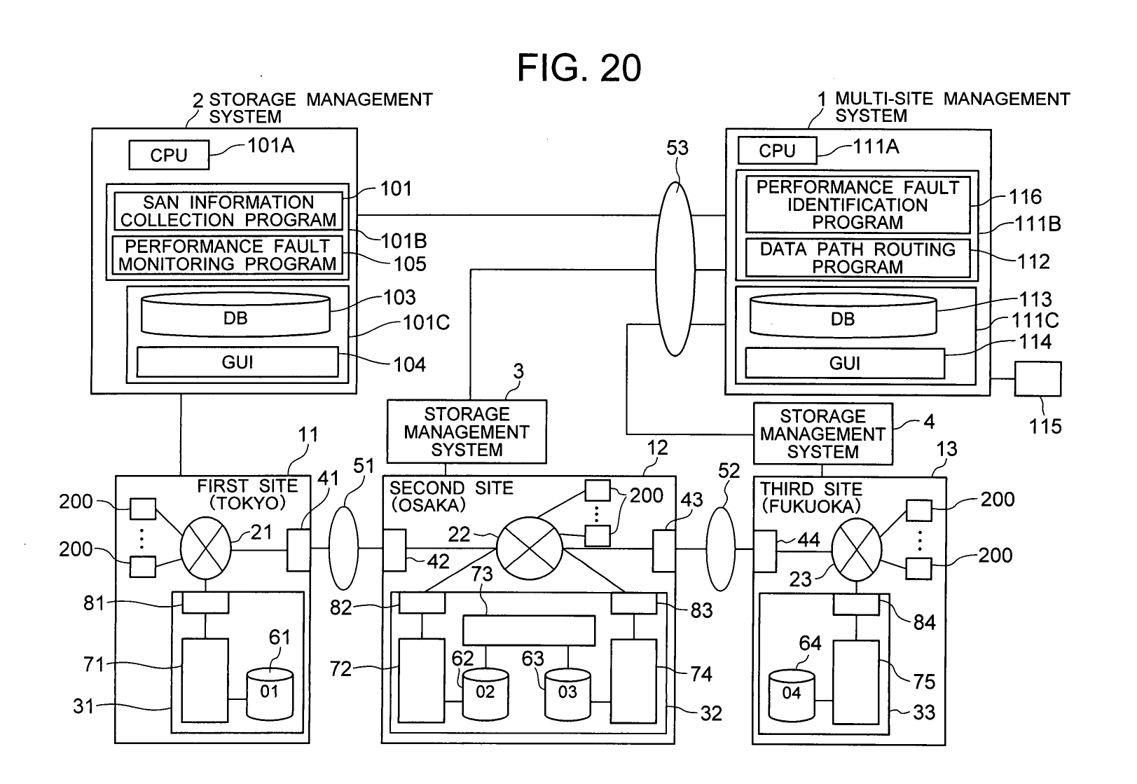

FIG. 20 is a block diagram generally illustrating an exemplary configuration of a system in the second embodiment of the present invention, where parts identical to those in the first embodiment are designated the same reference numerals, so that repeated descriptions will be omitted.

In FIG. 20, in the multi-site management system 1, a performance fault identification program 116 is loaded in the memory 111B instead of the fault identification program 111 (see FIG. 1) in the first embodiment. Also, in the storage management system 2, a performance fault monitoring program 105 is loaded in the memory 111B instead of the fault monitoring program 102 (see FIG. 1) in the first embodiment (the same applies to the storage management systems 3, 4).

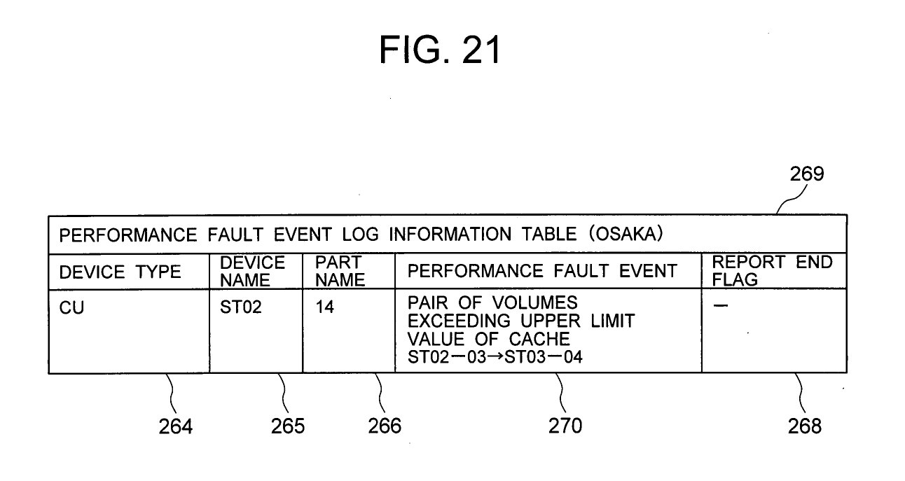

Then, the storage management system 2 manages a performance fault event log information table 269 shown in FIG. 21, resident in the DB 103. The performance fault event log information table 269 differs from the fault event log information tables 261-263 (see FIGS. 8-10) in that an item “performance fault event” 270 shown in FIG. 21 is substituted for the item “fault event” 267 in the fault event log information tables 261-263 (see FIGS. 8-10). Values in the performance fault event log information table 269 are updated by collecting information on a performance fault event from respective devices when the SAN information collection program 101 in each of the storage management systems 2-4 receives a performance fault notice in accordance with SNMP or the like.

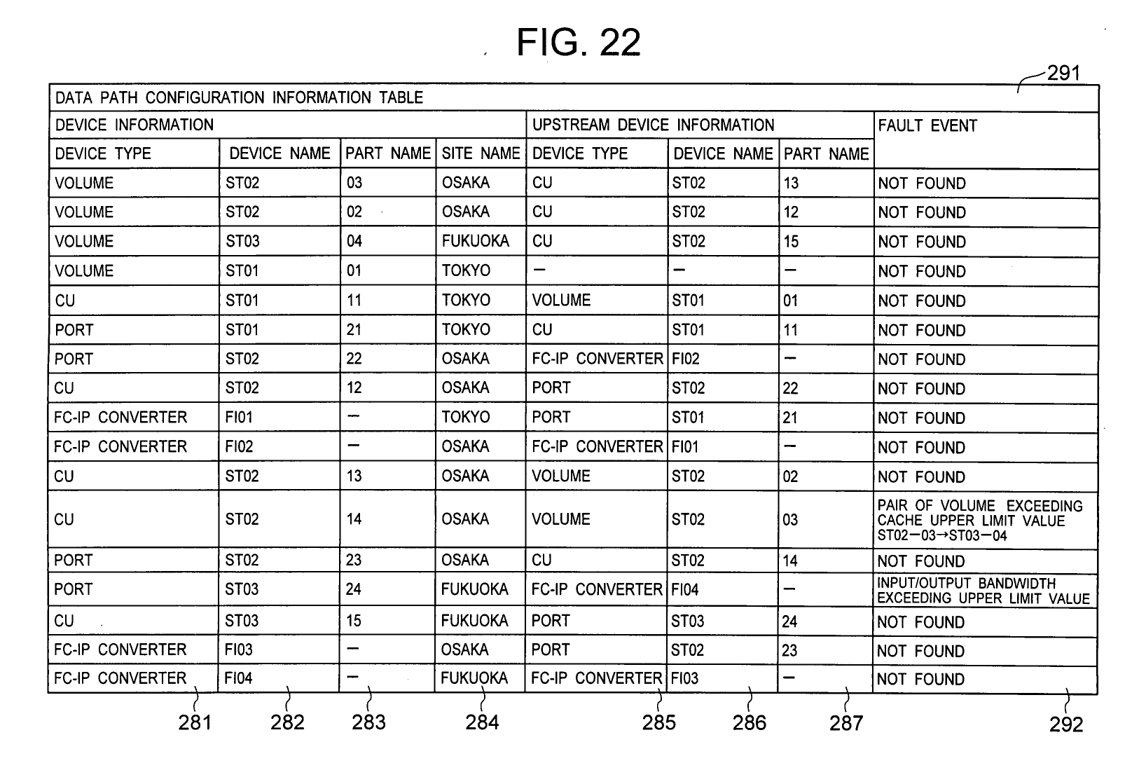

The performance fault identification program 116 creates a data path configuration information table 291 shown in FIG. 22 which is then stored in the DB 103. The data path configuration information table 291 also differs from the data path configuration information table 280 (see FIG. 14) in that an item “performance fault event” 292 is substituted for the item “fault event” 288 in the data path configuration information table 280 in FIG. 14. The remaining structure of the data path configuration information table 291 is substantially similar to the table 280 in the first embodiment.

Next, a description will be given of an exemplary process performed by the performance fault identification program 116 in FIG. 20 (see FIG. 1 and the like as appropriate). It should be noted that this exemplary process is substantially similar to the exemplary process comprising steps 601-612 in FIG. 15 except that a performance fault event is substituted for a fault event.

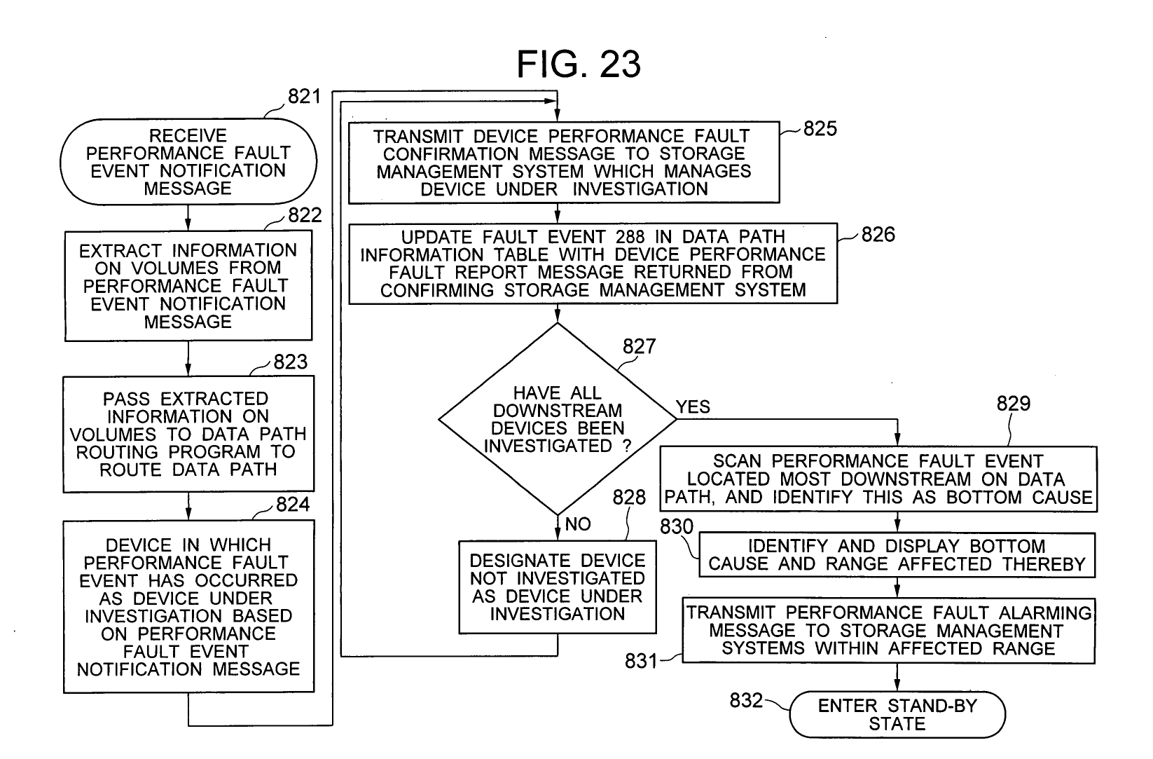

FIG. 23 is a flow chart illustrating the exemplary process performed by the performance fault identification program 116. Here, the description will be given on the assumption that the performance fault monitoring program 105 in the storage management system 3 (for managing the site in Osaka) detects a performance fault event on the first row in the performance fault event log information table 269, and transmits a performance fault notification message to the multi-site management system 1. The performance fault event notification message is the same as the fault event notification message in the first embodiment in structure except that it includes the item “performance fault event” 270 in the performance fault event log information table 269 (see FIG. 21).

In this process, the multi-site management system 1 receives the performance fault event notification message from the performance fault monitoring program 105 in the storage management system 3 (step 821), and starts the execution of the performance fault identification program 116 to perform the processing at step 822 onward.

At step 822, the performance fault identification program 116 extracts information on volumes from the received performance fault event notification message. Specifically, information (values in the items 224, 225 in FIG. 3) on the volume 63, which is a primary volume in a pair of volumes in which a performance fault has occurred, from information (values in the items 224-231 in FIG. 3) on the pair of volumes included in the performance fault event notification message.

At step 823, the extracted information on the volume is passed to the data path routing program 112 (see FIG. 20) for routing a data path. Specifically, the performance fault identification program 116 passes the information (the values in the items 224, 225 in FIG. 3) on the volume 63 extracted from the performance fault event notification message to the data path routing program 112, and requests the same to route a data path. Specifically, at step 823, upon receipt of the information (the values in the items 224, 225 in FIG. 3) on the volume 63, the data path routing program 112 routes a data path based on the information (the values in the items 224, 225 in FIG. 3) on the volume 63, and returns information on the configuration of the routed data path to the performance fault identification program 116 (see FIG. 20) in the form of the data path configuration information table 291.

At step 824, the performance fault identification program 116 designates a device shown in a performance fault event, from the performance fault event notification message, as a device under investigation. Specifically, upon receipt of the data path configuration information table 291 from the data path routing program 112, the performance fault identification program 116 designates a device shown in a performance fault event included in the performance fault event notification message as a device under investigation.

At step 825, a device performance fault confirmation message is transmitted to a storage management system which manages the device under investigation. Specifically, the multi-site management system 1 transmits the device performance fault confirmation message which contains values in the respective items “device type” 281, “device name” 282, and “part name” 283 in FIG. 14 to the storage management systems 2-4 which manage the sites 11-13, respectively, of volumes associated with the device under investigation.

Upon receipt of the device performance fault confirmation message from the multi-site management system 1, each of the storage management systems 2-4 searches the performance fault event log information table 269 (see FIG. 21) based on the device performance fault confirmation message. As a result of the search, if a performance fault event log is found in the item 270 of the performance fault event log information table 269 (see FIG. 21), each of the storage management systems 2-4 includes the performance fault event in a device performance fault report message which is then transmitted to the multi-site management system 1. On the other hand, when no performance fault event log is found, the value of “null” is included in the device performance fault report message for transmission to the multi-site management system 1.

At step 826, the value in the item 288 (fault event) in the data path configuration information table 291 (see FIG. 22) is updated with the device performance fault report messages transmitted from the storage management systems 2-4 which serve to confirm the performance fault event. Specifically, upon receipt of the device performance fault report messages from the storage management systems 2-4, the multi-site management system 1 stores the performance fault event (the value in the item 270 in FIG. 21) included in the device performance fault report message in the item “performance fault event” 292 in the data path configuration information table 291.

Immediately after step 826 is completed, the performance fault identification program 116 traces devices back to the upstream to confirm whether or not there is any device which can reach the device in which the performance fault event, included in the performance fault event notification message, has been detected (step 827). If such a device is found (No at step 827), the performance fault identification program 116 designates that device as a device under investigation (step 828), and returns to step 825 to perform the processing from then on.

On the other hand, when such a device is not found at step 827 (Yes at step 827), the performance fault identification program 116 finds out the performance fault event at the most downstream location on the data path, and identifies this performance fault event as a bottom cause (step 829). Specifically, at step 829, the performance fault identification program 116 searches the collected performance fault events for a performance fault event (the value in the item 292 in FIG. 22) which has occurred in the device at the most downstream location on the data path (which is most frequently traced from the device at the upstream end).

At step 830, the performance fault identification program 116 identifies and displays the bottom cause and a range affected thereby. Specifically, the performance fault identification program 116 identifies the performance fault event (the value in the item 292 in FIG. 22) found thereby as the bottom cause, identifies part of the data path upstream of the device included in the performance fault event notification message as a range affected by the performance fault, and displays the identified bottom cause and affected range, for example, on the display device of the computer.

At step 831, the performance fault identification program 116 transmits a performance fault alarming message to storage management systems which fall within the affected range, and proceeds to step 832 for entering a next performance fault event waiting state (stand-by state) (step 832). Specifically, the performance fault identification program 116 transmits the performance fault alarming message which includes the data path configuration information table 291 (see FIG. 22) to the storage management systems 2-4 which manage the sites (values in the item 284 in FIG. 22) that include devices within the range affected by the performance fault identified at step 830.

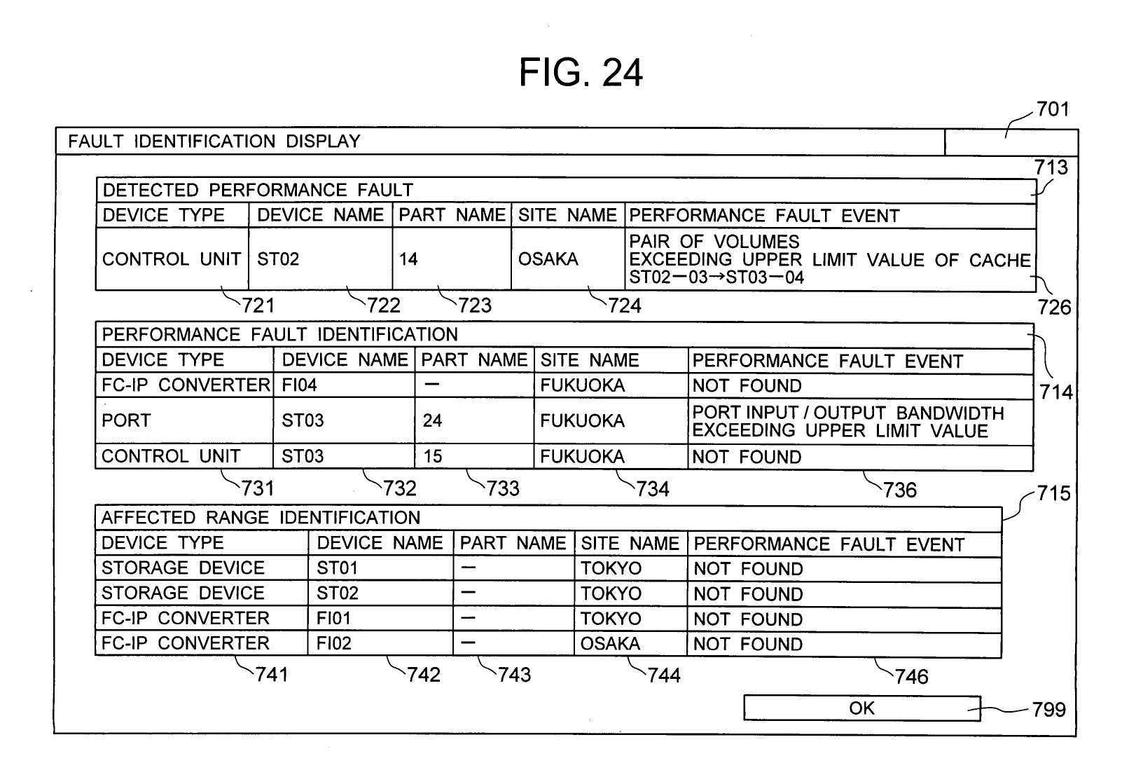

FIG. 24 shows an example of a displayed window 701 outputted to the GUI 114 at step 830. This exemplary display includes a detected performance fault display list 713, a performance fault identification display list 714, and an affected range identification display list 715. The window 701 differs from the window 700 in FIG. 18 in that these display lists 713-715 display contents of performance fault events.

The detected performance fault display list 713 (including items 721-724, 726) displays information (corresponding to the values in the items 281-284, 292 in FIG. 22) on a performance fault event received at step 821 in FIG. 23. If redundant paths are routed so that there are a plurality of upstream or downstream devices, information on these devices is all extracted from the data path configuration information table 291 (see FIG. 22) for display.

The performance fault identification display list 714 (including items 731-734, 736) displays information on a device in which a performance fault has been identified at step 830 in FIG. 23, and information on devices immediately upstream and downstream of the failed device.

The affected range identification display list 715 (items 741-744, 746) displays information on devices within the affected range identified at step 610.

At step 831 in FIG. 23, each of the storage management systems 2-4, which have received the performance fault alarming message from the multi-site management system 1, stores the data path configuration information table 291 (see FIG. 22) included in the performance fault alarming message in the DB.

Next, a description will be given of an exemplary process performed by the performance fault monitoring program 105 in each of the storage management systems 2-4. It should be noted that this exemplary process is substantially similar to the exemplary process comprising steps 680-689 in FIG. 19 except that a performance fault event is used instead of a fault event.

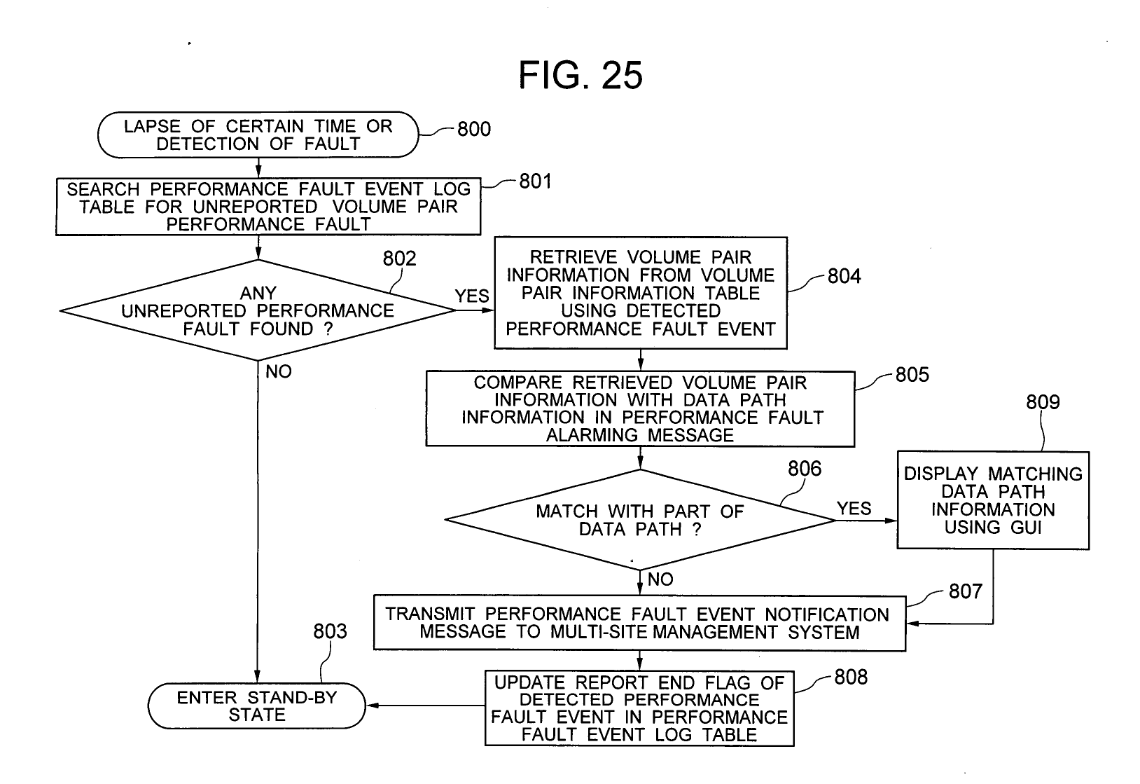

FIG. 25 is a flow chart illustrating the exemplary process of the performance fault monitoring program 105. While the storage management system 2 is given herein as an example for description, a similar process is also performed in the remaining storage management systems 3, 4 as well.

The performance fault monitoring program 105 in the storage management system 2 proceeds to step 801 when a certain time has elapsed or when a fault is detected by SNMP (step 800).

At step 801, the performance fault monitoring program 105 searches the performance fault event log information table 269 (see FIG. 21) in the storage management system 2, which is loaded with the performance fault monitoring program 105, for volume pair performance faults which have not been reported. Then, the performance fault monitoring program 105 determines from the result of the search whether or not any unreported performance fault is found (step 802). Specifically, the performance fault monitoring program 105 determines whether or not there is any performance fault event (related to a pair of volumes) on rows of the performance fault event log information table 269 (see FIG. 21) other than those which contain the report end flag indicative of “◯” (“◯” indicates a reported fault).

Then, if no unreported performance fault is found at step 802 (No at step 802), the performance fault monitoring program 105 enters a stand-by state (step 803). On the other hand, if any unreported performance fault is found at step 802 (Yes at step 802), the performance fault monitoring program 105 regards a performance fault event (performance fault event in the performance fault event log information table of FIG. 22), associated with the unreported performance fault, as a detected performance fault event, and retrieves volume pair information related to the detected performance fault event (the respective values in the items 224-231 in FIG. 2) from the volume pair information table 221 (see FIG. 2) using the detected fault event as a key (step 804).

At step 805, the performance fault monitoring program 105 compares the retrieved volume pair information with the data path information in the performance fault alarming message. A determination is made from the result of the comparison whether or not the volume pair information matches part of the data path (step 806). Specifically, the performance fault monitoring program 105 loaded in the storage management system 2 searches the data path configuration information table 291 in the received performance fault alarming message to determine whether or not the data path configuration information table 291 contains all the information on pairs of volumes (the respective values in the items 224-231 in FIG. 2) associated with the detected performance fault event, retrieved at step 804.

Then, if the result of the comparison at step 806 shows that the data path configuration information table 291 does not contain all the information (No at step 806), the performance fault monitoring program 105 transmits a performance fault event notification message to the multi-site management system 1 (step 807). Specifically, at step 807, the performance fault monitoring program 105 transmits to the multi-site management system 1 the performance fault event notification message which includes information on a device in which the detected performance fault event has occurred (the respective values in the items 264-266 in FIG. 21), and information on pairs of volumes (items 224-231 in FIG. 2).

Next, the performance fault monitoring program 105 updates the report end flag associated with the detected performance fault event in the performance fault event log information table 269 (step 808), and enters a stand-by state (step 803). Specifically, at step 808, the performance fault monitoring program 105 writes the symbol “◯” (indicating that the performance fault event has been reported) into the report end flag in the performance fault event log information table 269 (see FIG. 21).

On the other hand, if the data path configuration information table 291 (see FIG. 22) contains all the information at step 806 (Yes at step 806), the performance fault monitoring program 105 displays the window 701 (see FIG. 24) on the display device of the computer using the GUI 104 in the storage management system 2 (step 809), and executes the processing at step 807 onward.

It should be understood that the present invention is not limited to the first and second embodiments. For example, when a fault is caused in the control unit 71 in FIG. 1 due to a failure in a volume pair write, the SAN information collection program 101 in the storage management system 2 writes information on the fault into the fault event log information table 261. As this information is detected by the fault monitoring program 102 in the storage management system 2, a fault event notification message related to the fault is transmitted to the multi-site management system 1, as is done in the exemplary processing illustrated in FIG. 19.

Upon receipt of the fault event notification message, the fault identification program 111 in the multi-site management system 1 extracts information on volumes from the received fault event notification message, and passes the extracted information to the data path routing program 112 for routing a data path. In this event, information for routing a data path is similar to the data path configuration information table 280. Upon receipt of the data path configuration information table 280 from the data path routing program 112, the fault identification program 111 transmits a device fault confirmation message to the storage management systems 2-4 associated with the respective sites which manage devices located downstream of the control unit 71, in which the fault has been detected, on the data path, and reflects contents of device fault report messages returned thereto to the data path configuration information table 280. As a result, the fault identification program 111 identifies a write error of the volume 62 as the bottom cause for the fault and identifies the storage device 31 as being affected by the fault, because it has been revealed at step 609 that a volume write error is located in the volume 62 which is at the downstream end of the data path, and displays the identified bottom cause and affected range in the multi-site management system 1 using the fault identification display window 700 in FIG. 18. Then, the fault identification program 111 transmits a fault alarming message including the data path configuration information table 280 to the storage management system 2.

Another example will be described for the foregoing embodiments. When an internal program error of a remote copy occurs in the control unit 74 in FIG. 1, the SAN information collection program 101 in the storage management system 4 writes information or values into the fault event log information table 263. As the information is detected by the fault monitoring program 102 in the storage management system 4, the fault monitoring program 102 transmits a fault event notification message related to the detected fault to the multi-site management system 1. Upon receipt of the fault event notification message, the fault identification program 111 in the multi-site management system 1 extracts information on volumes from the received fault event notification message, and passes the extracted information to the data path routing program 112 for routing a data path. In this event, the information for routing a data path is similar to the data path information table 280. Upon receipt of the data path information table 280 from the data path routing program 112, the fault identification program 111transmits a device fault confirmation message to the storage management system 4 associated with the site which manages devices downstream of the control unit 74, in which the fault has been detected, on the data path, and reflects contents of a device fault report message returned thereto to the data path information table 280. As a result, the fault identification program 111 identifies the internal program error in the control unit 74 as the bottom cause for the fault and identifies the storage devices 31-33 and FC-IP converters 41-44 as being affected by the fault, because it has been revealed at step 609 in FIG. 15 that the internal program error is located in the control unit 74 which is at the downstream end of the data path, and displays the identified bottom cause and affected range in the multi-site management system 1 using the fault identification display window in FIG. 18. Then, the fault identification program 111 transmits a fault alarming message including the data path configuration information table 280 to the storage management systems 2-4.

While the first and second embodiments have been described to have the single multi-site management system 1, a plurality of multi-site management systems may be provided to distribute the processing among them. Also, while the storage management systems 2-4 are provided independently of the multi-site management system 1, the single multi-site management system 1 may be additionally provided with the functions of the storage management systems 2-4, by way of example. Further, while the storage management systems 2-4 are associated with the respective sites which manage them, they may be concentrated in a single storage management system in accordance with a particular operation scheme.

It should be further understood by those skilled in the art that although the foregoing description has been made on embodiments of the invention, the invention is not limited thereto and various changes and modifications may be made without departing from the spirit of the invention and the scope of the appended claims.

1. A storage management method executed by a computer system including a plurality of storage devices, management servers for managing said storage devices, respectively, and a computer for making communications with each of said management servers, wherein each said management server comprises a storage unit for storing connection information representing a connection topology of said storage device managed thereby, and volume pair information on a pair of volumes including a volume of said storage device and a volume paring with the volume of said storage device, said method comprising the steps of:
responsive to a notification of a fault received from said management server about a copy in one or a plurality of storage devices, said computer requesting a management server which manages a storage device that has a volume included in a pair of volumes associated with the notified fault to transmit the volume pair information on the pair of volumes;
responsive to the received transmission request, said management server retrieving the requested volume pair information from the storage unit, and transmitting the volume pair information to said computer;
upon receipt of the volume pair information, said computer requesting a storage device having a volume indicated in the volume pair information to transmit connection information representing a connection topology of said storage device;
responsive to the request for transmitting the connection information, said management server retrieving the requested connection information on said storage device from said storage unit, and transmitting the connection information to said computer; and
upon receipt of the connection information transmitted thereto, said computer identifying a relay path between the pair of volumes associated with the notified fault from the connection information, and displaying the relay path to the outside.

2. A storage management method according to claim 1, wherein said plurality of storage devices are distributed to a plurality of different sites, and said sites are interconnected through a network.

3. A storage management method according to claim 1, wherein said computer identifies the relay path between the pair of volumes by making an inquiry about a relay order to all relay devices located on relay paths between all pairs of volumes which start from a source volume.

4. A storage management method according to claim 3, wherein said identified relay path comprises relay paths between a plurality of pairs of volumes.

5. A storage management method according to claim 3, wherein said relay device includes at least one of a controller for said storage device, and a port of said storage device.

6. A storage management method according to claim 3, wherein said computer identifies the relay path by placing the relay devices on the relay path in the inquired relay order.

7. A storage management method according to claim 1, further comprising the step of:
said computer displaying the identified relay path by collecting fault events related to relay devices located downstream of a source volume in the pair of volumes associated with the notified fault on the relay path, identifying a cause for the notified fault from the fault events, and displaying the identified cause for the fault together with the relay path.

8. A storage management method according to claim 1, further comprising the step of:
said computer notifying devices located upstream of a source volume in the pair of volumes associated with the notified fault on the relay path that said devices are identified as falling within a range affected by the fault.

9. A storage system including a plurality of storage devices, management servers for managing said storage devices, respectively, and a computer for making communications with each of said management servers, wherein:
each said management server comprises a storage unit for storing connection information representing a connection topology of said storage device managed thereby, and volume pair information on a pair of volumes including a volume of said storage device and a volume paring with the volume of said storage device,
said computer, responsive to a notification of a fault received from said management server about a copy in one or a plurality of storage devices, requests a management server which manages a storage device that has a volume included in a pair of volumes associated with the notified fault to transmit the volume pair information on the pair of volumes,
said management server, responsive to the received transmission request, retrieves the requested volume pair information from the storage unit, and transmits the volume pair information to said computer,
said computer, upon receipt of the volume pair information, requests a storage device having a volume indicated in the volume pair information to transmit connection information representing a connection topology of said storage device,
said management server, responsive to the request for transmitting the connection information, retrieves the requested connection information on said storage device from said storage unit, and transmits the connection information to said computer, and
said computer, upon receipt of the connection information transmitted thereto, identifies a relay path between the pair of volumes associated with the notified fault from the connection information, and displays the relay path to the outside.

10. A storage system according to claim 9, wherein said plurality of storage devices are distributed to a plurality of different sites, and said sites are interconnected through a network.

11. A storage system according to claim 9, wherein said computer identifies the relay path between the pair of volumes by making an inquiry about a relay order to all relay devices located on relay paths between all pairs of volumes which start from a source volume.

12. A storage system according to claim 11, wherein said identified relay path comprises relay paths between a plurality of pairs of volumes.

13. A storage system according to claim 11, wherein said relay device includes at least one of a controller for said storage device, and a port of said storage device.

14. A storage system according to claim 11, wherein said computer identifies the relay path by placing the relay devices on the relay path in the inquired relay order.

15. A storage system according to claim 9, wherein said computer displays the identified relay path by collecting fault events related to relay devices located downstream of a source volume in the pair of volumes associated with the notified fault on the relay path, identifying a cause for the notified fault from the fault events, and displaying the identified cause for the fault together with the relay path.

16. A storage system according to claim 9, wherein said computer further notifies devices located upstream of a source volume in the pair of volumes associated with the notified fault on the relay path that said devices are identified as falling within a range affected by the fault.
